(19) United States
(12) Patent Application Publication
(10) Pub. No.: US 2025/0044575 A1
(43) Pub. Date: Feb. 6, 2025

(54) WAVELENGTH CONVERSION DEVICE, LIGHT SOURCE DEVICE, AND PROJECTOR

(71) Applicant: SEIKO EPSON CORPORATION, Tokyo (JP)

(72) Inventors: Kosuke TABAYASHI, AZUMINO-SHI (JP); Norikazu KADOTANI, AZUMINO-SHI (JP)

(21) Appl. No.: 18/790,882

(22) Filed: Jul. 31, 2024

(30) Foreign Application Priority Data
Jul. 31, 2023 (JP) 2023-124658

(51) Int. Cl. G02B 26/00; G03B 21/20

(52) U.S. Cl. CPC G02B 26/008; G03B 21/204

(57) ABSTRACT

A wavelength conversion device includes a rotating plate, a wavelength converter disposed further on the outer side than an opening in a radial direction of the rotating plate, a rotating body coupled to the rotating plate, a driving source configured to rotate the rotating plate and the rotating body centering on a rotation axis, a suction part configured by combining the rotating plate and the rotating body, provided on an inner side of the opening of the rotating plate, and communicating with, via the opening, a space on a side opposite to the driving source with respect to the rotating plate, a plurality of fins rotated together with the rotating plate, and a plurality of flow paths provided among the fins and configured to cause an air flow flowing into an inside of the suction part via the opening to flow to the outside of the rotating body.

The present application is based on, and claims priority from JP Application Serial Number 2023-124658, filed Jul. 31, 2023, the disclosure of which is hereby incorporated by reference herein in its entirety.

### BACKGROUND

### 1. Technical Field

The present disclosure relates to a wavelength conversion device, a light source device, and a projector.

### 2. Related Art

There has been known a phosphor wheel device including a substrate on which a phosphor region containing a phosphor is provided (see, for example, JP-A-2018-60175).

The phosphor wheel device described in JP-A-2018-60175 absorbs excitation light made incident on the phosphor region and emits fluorescent light. The phosphor region is provided on a circumference having a first radius from a rotation center of the substrate. The substrate has a ventilation region closer to a rotation axis of the substrate than the phosphor region. The ventilation region includes a plurality of first openings and a plurality of second openings.

The shape of the first openings is a quadrangular shape. The first openings are provided on a circumference having a second radius smaller than the first radius from the rotation center of the substrate. The shape of the second openings is a circular shape. The second openings are provided on a circumference having a third radius smaller than the second radius from the rotation center of the substrate.

A plurality of fins are provided on a surface on the opposite side to a front surface on which the phosphor region is provided on the substrate. The plurality of fins are provided on the circumference having the third radius from the rotation center of the substrate. That is, the fins and the second openings are alternately provided on the circumference having the third radius from the rotation center of the substrate.

JP-A-2018-60175 explained above assumes that, when the substrate is rotated by a motor, an air flow generated by the plurality of fins passes through the first openings and the second openings and goes around to the front surface side of the substrate, whereby heat radiation efficiency from the front surface of the phosphor wheel device is improved.

JP-A-2018-60175 is an example of the related art.

Here, in the phosphor wheel device described in JP-A-2018-60175, the air flow generated by the plurality of fins when the substrate is rotated flows toward the plurality of fins first and thereafter flows in a direction opposite to the rotation axis of the substrate. For this reason, in the air flow generated by the plurality of fins provided on the rear surface side of the substrate, the air flow flowing to the front surface side of the substrate via the plurality of first openings and the plurality of second openings is only a little. For this reason, it is likely that the phosphor region cannot be sufficiently cooled.

On the other hand, it is conceivable that, when the substrate is rotated, the air flow flows from the front surface side of the substrate toward the fins via the second openings provided alternately with the fins n the circumference having the third radius. However, the plurality of second openings are separated from the rotation axis of the substrate. For this reason, since the air flow reaching the fins from the front surface side of the substrate via the second opening flows from the fins in the direction opposite to the rotation axis of the substrate, the air flow less easily flows to the motor. Therefore, there is a problem in that it is difficult to cool the motor.

For this reason, a configuration that can improve the cooling efficiency of each of a phosphor and a driving source has been demanded.

### SUMMARY

A wavelength conversion device according to a first aspect of the present disclosure includes: a rotating plate having a first surface, a second surface on an opposite side to the first surface, and an opening penetrating the rotating plate from the first surface to the second surface; a wavelength converter disposed further on an outer side than the opening on the rotating plate and configured to emit converted light obtained by converting a wavelength of excitation light made incident on the wavelength converter; a rotating body coupled to the rotating plate; a driving source configured to rotate the rotating plate and the rotating body centering on a rotation axis; a suction part configured by combining the rotating plate and the rotating body, provided on an inner side of the opening when viewed from a side opposite to the driving source with respect to the rotating plate, and communicating with, via the opening, a space on the side opposite to the driving source with respect to the rotating plate; a plurality of fins respectively extending from a portion on the rotation axis side toward an outer side of the rotating plate, disposed side by side around the suction part, and rotated together with the rotating plate by the driving source; and a plurality of flow paths provided among the plurality of fins and configured to cause an air flow flowing into an inside of the suction part via the opening to flow to an outside of the rotating body.

A light source device according to a second aspect of the present disclosure includes: the wavelength conversion device according to the first aspect; a case housing the wavelength conversion device; and a light source configured to emit excitation light to be made incident on the wavelength conversion device, wherein the case includes a light emitting unit configured to emit the converted light to an outside.

A projector according to a third aspect of the present disclosure includes: the light source device according to the second aspect; an image forming device configured to modulate light emitted from the light source device to form image light; and a projection optical device configured to project the image light formed by the image forming device.

### BRIEF DESCRIPTION OF THE DRAWINGS

FIG. 1 is a schematic diagram illustrating a configuration of a projector according to a first embodiment.

FIG. 2 is a schematic diagram illustrating a configuration of a light source device according to the first embodiment.

FIG. 3 is a perspective view illustrating a wavelength conversion device according to the first embodiment.

FIG. 4 is a perspective view illustrating the wavelength conversion device according to the first embodiment.

FIG. 5 is a diagram illustrating the wavelength conversion device according to the first embodiment.

FIG. 6 is a diagram illustrating the wavelength conversion device according to the first embodiment.

FIG. 7 is a perspective view illustrating a driving source according to the first embodiment.

FIG. 8 is a perspective view illustrating a rotating body according to the first embodiment.

FIG. 9 is a perspective view illustrating the rotating body according to the first embodiment.

FIG. 10 is a schematic diagram illustrating an air flow flowing to the wavelength conversion device according to the first embodiment.

FIG. 11 is a perspective view illustrating a wavelength conversion device of a light source device provided in a projector according to a second embodiment.

FIG. 12 is a perspective view illustrating the wavelength conversion device according to the second embodiment.

FIG. 13 is an exploded perspective view illustrating the wavelength conversion device according to the second embodiment.

FIG. 14 is an exploded perspective view illustrating the wavelength conversion device according to the second embodiment.

FIG. 15 is a cross-sectional view illustrating the wavelength conversion device according to the second embodiment.

FIG. 16 is a perspective view illustrating a wavelength conversion device of a light source device provided in a projector according to a third embodiment.

FIG. 17 is a perspective view illustrating a wavelength conversion device of a light source device provided in a projector according to a fourth embodiment.

FIG. 18 is a perspective view illustrating a wavelength conversion device of a light source device provided in a projector according to a fifth embodiment.

FIG. 19 is a diagram illustrating a first modification of a phosphor wheel according to the first embodiment.

FIG. 20 is a diagram illustrating a second modification of the phosphor wheel according to the first embodiment.

### DESCRIPTION OF EMBODIMENTS

### First Embodiment

In the following explanation, a first embodiment of the present disclosure is explained with reference to the drawings.

### Schematic Configuration of a Projector

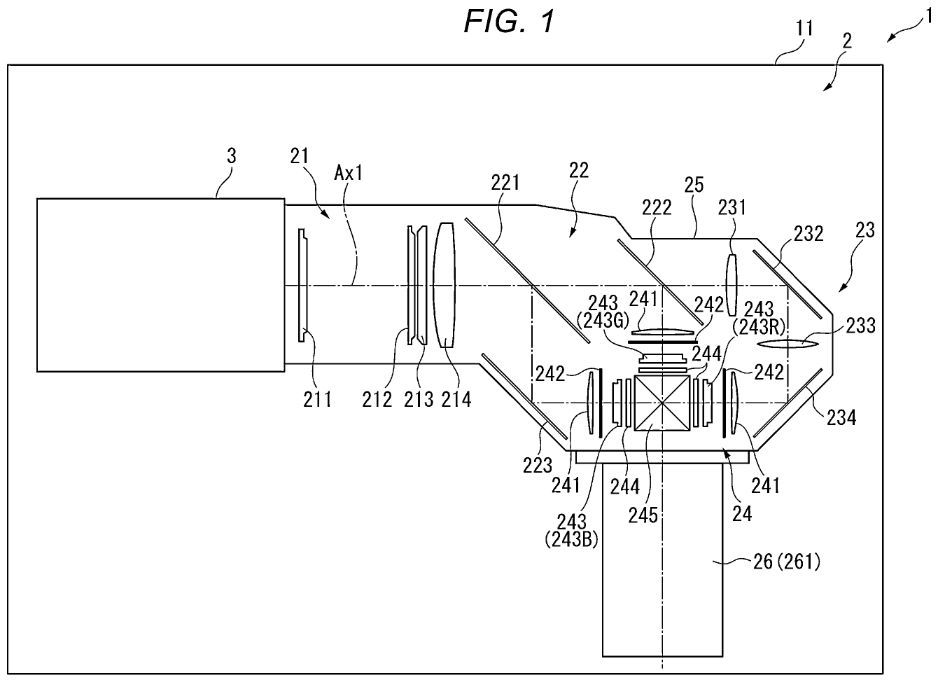

FIG. 1 is a schematic diagram illustrating a configuration of a projector 1 according to the present embodiment.

The projector 1 according to the present embodiment projects image light corresponding to image information. As illustrated in FIG. 1, the projector 1 includes an exterior housing 11 and an image projection device 2 housed in the exterior housing 11. Besides, although not illustrated, the projector 1 includes a control device that controls an operation of the projector 1, a power supply device that supplies electric power to electronic components of the projector 1, and a cooling device that cools a cooling target of the projector 1.

### Configuration of the Image Projection Device

The image projection device 2 forms image light corresponding to image information to be input and projects the formed image light. The image projection device 2 includes a light source device 3, a uniformizing optical system 21, a color separation optical system 22, a relay optical system 23, an image forming device 24, an optical component housing 25, and a projection optical device 26.

The light source device 3 emits illumination light to the uniformizing optical system 21. A configuration of the light source device 3 is explained in detail below.

The uniformizing optical system 21 uniformizes the illumination light emitted from the light source device 3. The uniformized illumination light passes through the color separation optical system 22 and the relay optical system 23 and illuminates modulation regions of light modulators 243 explained below. The uniformizing optical system 21 includes two lens arrays 211 and 212, a polarization converter 213, and a superimposing lens 214.

The color separation optical system 22 separates the illumination light made incident from the uniformizing optical system 21 into color lights of red, green, and blue. The color separation optical system 22 includes two dichroic mirrors 221 and 222 and a reflection mirror 223 that reflects the blue light separated by the dichroic mirror 221.

The relay optical system 23 is provided in an optical path of the red light longer than optical paths of the other color lights and reduces a loss of the red light. The relay optical system 23 includes an incident side lens 231, a relay lens 233, and reflection mirrors 232 and 234. In the present embodiment, the red light is guided to the relay optical system 23. However, not only this, but, for example, a configuration may be adopted in which colored light having a longer optical path than other colored lights is the blue light and the blue light is guided to the relay optical system 23.

The image forming device 24 modulates the color lights of red, green, and blue made incident thereon and combines the modulated colored lights to form image light. The image forming device 24 includes three field lenses 241, three incident-side polarization plates 242, three light modulators 243, and three emission-side polarization plates 244 provided according to the incident color lights and one color combination optical system 245.

The light modulator 243 modulates light from the light source device 3 to form image light. Specifically, the light modulator 243 modulates, according to an image signal, color light made incident from the incident-side polarization plate 242 and emits the modulated color light. The three light modulators 243 include a light modulator 243R that modulates red light, a light modulator 243G that modulates green light, and a light modulator 243B that modulates blue light. Examples of the light modulator 243 include a liquid crystal panel of a transmission type.

The color combination optical system 245 combines the three color lights modulated by the light modulators 243R, 243G, and 243B. Image light combined by the color combination optical system 245 is made incident on the projection optical device 26. In the present embodiment, the color combination optical system 245 is configured by a cross dichroic prism having a substantially rectangular parallelepiped shape. However, the color combination optical system 245 may be configured by a plurality of dichroic mirrors.

The optical component housing 25 houses, on the inside thereof, the uniformizing optical system 21, the color separation optical system 22, the relay optical system 23, and the image forming device 24. An optical axis Ax1 in design is set in the image projection device 2. The optical component housing 25 holds the uniformizing optical system 21, the color separation optical system 22, the relay optical system 23, and the image forming device 24 at predetermined positions on the optical axis Ax1. The light source device 3 and the projection optical device 26 are disposed at predetermined positions on the optical axis Ax1.

The projection optical device 26 projects image light made incident from the image forming device 24 onto a projection surface such as a screen. That is, the projection optical device 26 projects image light formed by the image forming device 24. The projection optical device 26 may be, for example, a group lens including a not-illustrated plurality of lenses and a lens barrel 261 that houses the plurality of lenses.

### Configuration of the Light Source Device

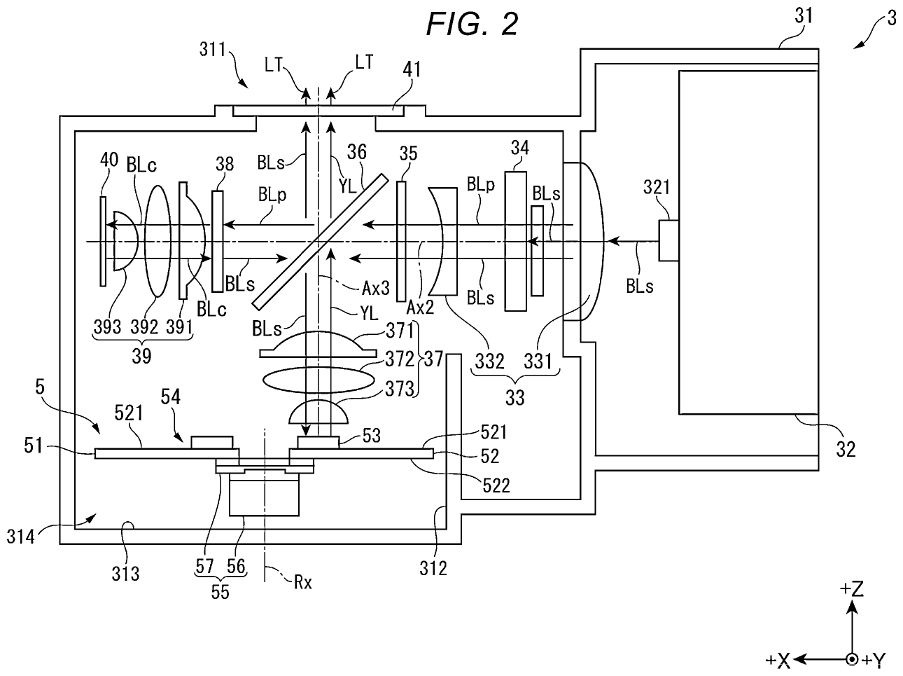

FIG. 2 is a schematic diagram illustrating the light source device 3.

The light source device 3 emits the illumination light for illuminating the image forming device 24 to the uniformizing optical system 21. As illustrated in FIG. 2, the light source device 3 includes a light source housing 31, a light source 32, an afocal optical element 33, a first retarder 34, a transmissive diffuser 35, a light separation and combination element 36, a first condenser 37, a second retarder 38, a second condenser 39, a diffuser 40, a third retarder 41, and a wavelength conversion device 5.

An optical axis Ax2 extending linearly and an optical axis Ax3 orthogonal to the optical axis Ax2 and extending linearly are set in the light source device 3. The optical axis Ax3 overlaps the optical axis Ax1 in the uniformizing optical system 21.

The light source 32, the afocal optical element 33, the first retarder 34, the transmissive diffuser 35, the light separation and combination element 36, the second retarder 38, the second condenser 39, and the diffuser 40 are disposed on the optical axis Ax2.

The wavelength conversion device 5, the first condenser 37, the light separation and combination element 36, and the third retarder 41 are disposed on the optical axis Ax3.

In the following explanation, three directions orthogonal to one another are referred to as +X direction, +Y direction, and +Z direction. In the present embodiment, the +X direction is a direction in which the light source 32 emits light along the optical axis Ax2 and the +Z direction is a direction in which the light source device 3 emits illumination light along the optical axis Ax3. Although not illustrated, a direction opposite to the +X direction is referred to as −X direction, a direction opposite to the +Y direction is referred to as −Y direction, and a direction opposite to the +Z direction is referred to as −Z direction.

### Configuration of the Light Source Housing

The light source housing 31 houses the light source 32, the afocal optical element 33, the first retarder 34, the transmissive diffuser 35, the light separation and combination element 36, the first condenser 37, the second retarder 38, the second condenser 39, the diffuser 40, the third retarder 41, and the wavelength conversion device 5. The light source housing 31 is a sealed housing into which dust and the like less easily enter.

A detailed configuration of the light source housing 31 is explained in detail below.

### Configuration of the Light Source

The light source 32 includes at least one solid-state light emitting element 321. The at least one solid-state light emitting element 321 emits, in the +X direction, light made incident on the diffuser 40 and the wavelength conversion device 5. The solid-state light emitting element 321 emits blue light, which is excitation light. For example, the solid-state light emitting element 321 is an LD (Laser Diode) that emits laser light having a peak wavelength of 440 nm.

The light emitted by the light source 32 is s-polarized blue light BLs for the light separation and combination element 36.

However, not only this, but the light emitted by the light source 32 may be p-polarized blue light BLp for the light separation and combination element 36 or may be blue light in which s-polarized light and p-polarized light are mixed. In the latter case, the first retarder 34 can be omitted.

### Configuration of the Afocal Optical Element

The afocal optical element 33 adjusts a light flux diameter of the blue light BLs made incident in the +X direction from the light source 32. The afocal optical element 33 includes a lens 331 that collects light made incident thereon and a lens 332 that collimates a light flux collected by the lens 331. The afocal optical element 33 may be absent.

### Configuration of the First Retarder

The first retarder 34 is provided between the lens 331 and the lens 332. The first retarder 34 converts a part of the blue light BLs made incident thereon into the blue light BLp and emits light including the s-polarized blue light BLs and the p-polarized blue light BLp. The first retarder 34 may be rotated by a rotating device centering on a rotation axis extending along the optical axis Ax2. In this case, a ratio of an s-polarized light component and a p-polarized light component in the blue light emitted from the first retarder 34 can be adjusted according to a rotation angle of the first retarder 34.

### Configuration of the Transmissive Diffuser

The transmissive diffuser 35 equalizes an illuminance distribution of the blue lights BLp and BLs made incident in the +X direction from the lens 332. The blue lights BLs and BLp having passed through the transmissive diffuser 35 is made incident on the light separation and combination element 36. Examples of the transmissive diffuser 35 include a configuration having a hologram, a configuration in which a plurality of small lenses are arrayed in a plane orthogonal to an optical axis, and a configuration in which a surface through which light passes is a rough surface.

Instead of the transmissive diffuser 35, a homogenizer optical element including a pair of multi-lenses may be adopted.

### Configuration of the Light Separation and Combination Element

The light separation and combination element 36 has a function of a light separation element that separates light made incident thereon and a function of a light combination element that combines lights made incident thereon from two directions.

The light separation and combination element 36 is a polarized beam splitter and separates an s-polarized light component and a p-polarized light component contained in light made incident thereon. Specifically, the light separation and combination element 36 reflects the s-polarized light component and transmits the p-polarized light component. The light separation and combination element 36 has a color separation characteristic of transmitting light having a predetermined wavelength or more regardless of whether a polarized light component is an s-polarized light component or a p-polarized light component. Therefore, of the blue lights BLp and BLs made incident on the light separation and combination element 36 from the transmissive diffuser 35, the p-polarized blue light BLp is transmitted through the light separation and combination element 36 in the +X direction and is made incident on the second retarder 38. On the other hand, the s-polarized blue light BLs is reflected in the −Z direction by the light separation and combination element 36 and is made incident on the first condenser 37.

The light separation and combination element 36 may have a function of a half mirror that transmits a part of light made incident from the light source 32 via the transmissive diffuser 35 and reflects the remaining light and a function of a dichroic mirror that reflects blue light made incident from the diffuser 40 and transmits fluorescent light made incident from the wavelength conversion device 5 and having a wavelength longer than a wavelength of the blue light. In this case, the first retarder 34 can be omitted.

### Configuration of the First Condenser

The first condenser 37 configures a pickup optical system. The first condenser 37 condenses, on a wavelength converter 53 explained below of a phosphor wheel 51 provided in the wavelength conversion device 5, the blue light BLs reflected in the −Z direction by the light separation and combination element 36. The first condenser 37 collimates fluorescent light YL made incident in the +Z direction from the wavelength converter 53 and emits the collimated fluorescent light YL to the light separation and combination element 36. In the present embodiment, the first condenser 37 includes three lenses 371, 372, and 373. However, the number of lenses provided in the first condenser 37 does not matter.

### Schematic Configuration of the Wavelength Conversion Device

The wavelength conversion device 5 includes the phosphor wheel 51 that converts a wavelength of the blue light BLs made incident from the first condenser 37 and emits the fluorescent light YL. The phosphor wheel 51 is a wavelength conversion device of a so-called reflection type and emits the fluorescent light YL in a direction opposite to an incident direction of the blue light BLs, which is excitation light. A configuration of the wavelength conversion device 5 is explained in detail below.

The fluorescent light YL emitted from the wavelength conversion device 5 in the +Z direction is collimated by the first condenser 37 and is thereafter made incident on the light separation and combination element 36. As explained above, since the light separation and combination element 36 has a characteristic of transmitting the fluorescent light YL, the fluorescent light YL made incident on the light separation and combination element 36 in the +Z direction is transmitted through the light separation and combination element 36 and made incident on the third retarder 41.

### Configuration of the Second Retarder

The second retarder 38 is disposed in the +X direction with respect to the light separation and combination element 36. That is, the second retarder 38 is disposed between the light separation and combination element 36 and the second condenser 39. The second retarder 38 converts the blue light BLp having passed through the light separation and combination element 36 in the +X direction into circularly polarized blue light BLC. The blue light BLc having passed through the second retarder 38 in the +X direction is made incident on the second condenser 39.

### Configuration of the Second Condenser

The second condenser 39 condenses, on the diffuser 40, the blue light BLc transmitted through the light separation and combination element 36 in the +X direction and made incident from the second retarder 38. The second condenser 39 collimates light made incident in the −X direction from the diffuser 40 and emits the collimated light to the second retarder 38.

In the present embodiment, the second condenser 39 includes three lenses 391, 392, and 393. However, the number of lenses provided in the second condenser 39 does not matter.

### Configuration of the Diffuser

The diffuser 40 diffuses, at the same diffusion angle as a diffuse angle of the fluorescent light YL emitted from the wavelength conversion device 5, the blue light BLC made incident thereon. Specifically, the diffuser 40 reflects and diffuses, in the −X direction, the blue light BLc made incident in the +X direction from the second condenser 39. The diffuser 40 is a reflective element for causing the blue light BLc made incident thereon to perform Lambert reflection. The diffuser 40 may be rotated by the rotating device centering on a rotation axis parallel to the optical axis Ax2.

The blue light BLc diffused by the diffuser 40 passes through the second condenser 39 and is thereafter made incident on the second retarder 38. When the blue light BLc made incident on the diffuser 40 is reflected by the diffuser 40, the blue light BLc is converted into circularly polarized light, a rotating direction of which is opposite to a rotating direction of the blue light BLC. For this reason, the blue light BLc made incident on the second retarder 38 via the second condenser 39 is converted into the s-polarized blue light BLs by the second retarder 38. Then, the blue light BLs is reflected in the +Z direction by the light separation and combination element 36 and is made incident on the third retarder 41. That is, the light made incident on the third retarder 41 from the light separation and combination element 36 is white light in which the blue light BLs and the fluorescent light YL are mixed.

### Configuration of the Third Retarder

The third retarder 41 converts the white light including the blue light BLs and the fluorescent light YL made incident from the light separation and combination element 36 into white light in which s-polarized light and p-polarized light are mixed. The white light converted as explained above is emitted in the +Z direction as illumination light LT and is incident on the uniformizing optical system 21 explained above.

### Configuration of the Wavelength Conversion Device

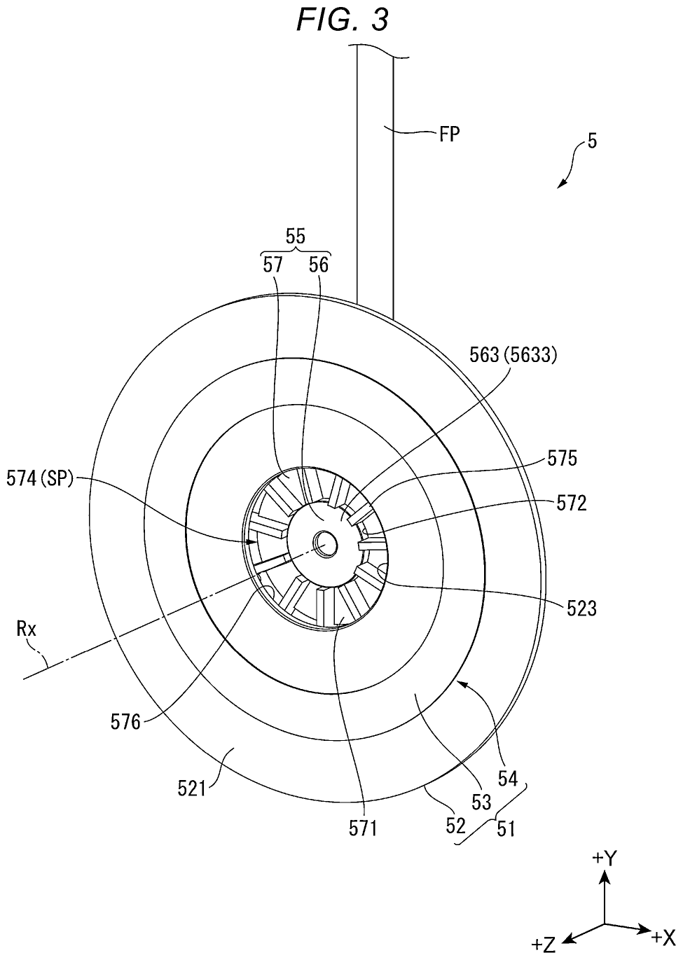

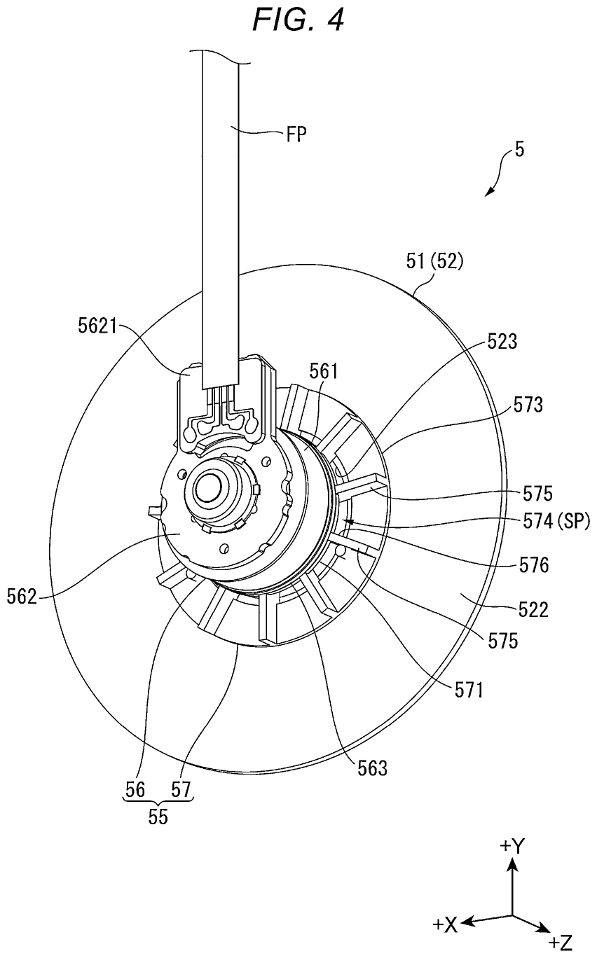

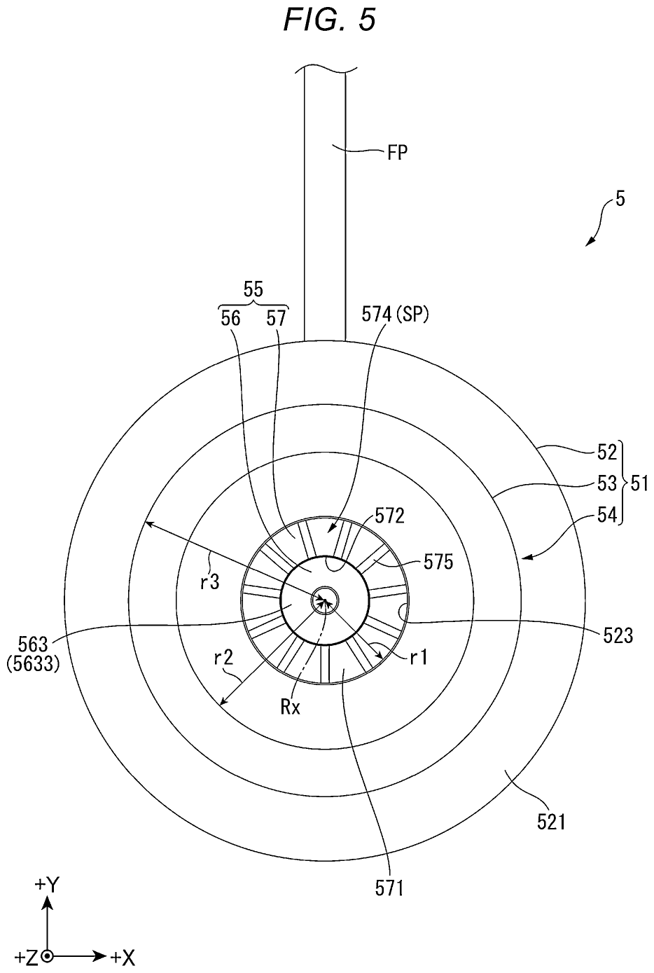

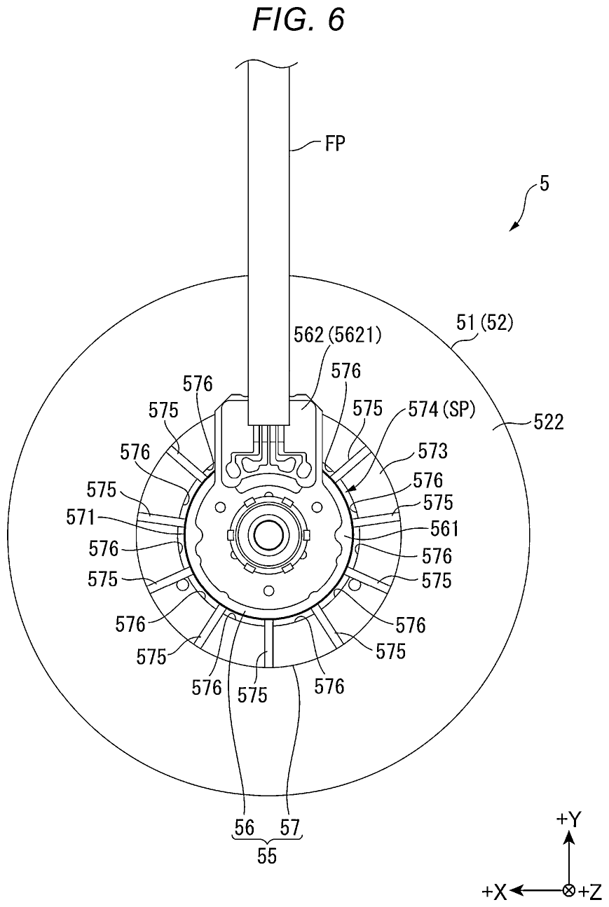

FIGS. 3 and 4 are perspective views illustrating the wavelength conversion device 5. Specifically, FIG. 3 is a perspective view illustrating the wavelength conversion device 5 viewed from an incident side of an excitation light and FIG. 4 is a perspective view illustrating the wavelength conversion device 5 viewed from a side opposite to the incident side of the excitation light. FIG. 5 is a diagram illustrating the wavelength conversion device 5 viewed from the incident side of the excitation light and FIG. 6 is a diagram illustrating the wavelength conversion device 5 viewed from the side opposite to the incident side of the excitation light.

As explained above, the wavelength conversion device 5 emits the converted light obtained by converting the wavelength of the excitation light made incident thereon. Specifically, the wavelength conversion device 5 converts a wavelength of blue light made incident thereon and emits fluorescent light including green light and red light. As illustrated in FIGS. 3 to 6, the wavelength conversion device 5 includes the phosphor wheel 51 and a driving device 55.

In the following explanation, the −Z direction is a direction in which excitation light is made incident on the wavelength conversion device 5. The +Z direction is the incident side of the excitation light in the wavelength conversion device 5. The −Z direction is an opposite side to the incident side of the excitation light in the wavelength conversion device 5.

### Configuration of the Phosphor Wheel

The phosphor wheel 51 is rotated centering on a rotation axis Rx by the driving device 55, converts a wavelength of excitation light made incident thereon, and emits the fluorescent light YL, which is converted light. The phosphor wheel 51 includes a rotating plate 52, a wavelength converter 53, and a reflecting part 54.

### Configuration of the Rotating Plate

The rotating plate 52 is formed in a disk shape centered on the rotation axis Rx. The rotating plate 52 has a first surface 521, a second surface 522, and an opening 523.

The first surface 521 is a surface orthogonal to the rotation axis Rx and is a surface facing the +Z direction in the rotating plate 52. That is, the first surface 521 is a surface on a side opposite to the driving device 55 in the rotating plate 52. The wavelength converter 53 is provided on the first surface 521.

The second surface 522 is a surface orthogonal to the rotation axis Rx and is a surface on a side opposite to the first surface 521 in the rotating plate 52. In other words, the second surface 522 is a surface on the driving device 55 side in the rotating plate 52 and faces the −Z direction. A rotating body 57 explained below of the driving device 55 is coupled to the second surface 522.

The opening 523 penetrates the rotating plate 52 from the first surface 521 to the second surface 522. That is, the opening 523 penetrates the rotating plate 52 along the rotation axis Rx parallel to a Z axis. For this reason, an air flow can flow from one surface side to the other surface side in the first surface 521 and the second surface 522 via the opening 523.

As illustrated in FIG. 5, the opening 523 is formed in a range of a radius r1 centering on the rotation axis Rx. That is, the opening 523 includes an extension line of the rotation axis Rx when viewed from the +Z direction.

The opening 523 overlaps a driving source 56 when viewed from the +Z direction along the rotation axis Rx. Specifically, the opening 523 overlaps a motor 561 configuring the driving source 56 when viewed from the +Z direction along the rotation axis Rx. A fitting part 5633 of a hub 563 configuring the driving source 56 and coupled to the motor 561 is exposed in the opening 523.

### Configuration of the Wavelength Converter

The wavelength converter 53 contains a phosphor that is excited by excitation light being made incident thereon and emits converted light having a wavelength longer than a wavelength of the excitation light. In the present embodiment, the phosphor emits the fluorescent light YL having a wavelength longer than a wavelength of the blue light BLs, which is excitation light.

As illustrated in FIGS. 3 and 5, the wavelength converter 53 is formed in a ring shape centered on the rotation axis Rx when viewed from the +Z direction and is fixed to the first surface 521 of the rotating plate 52. Specifically, the wavelength converter 53 is provided in a range of a radius r2 or more and a radius r3 or less centered on the rotation axis Rx. The radius r2 is larger than the radius r1 and the radius r3 is larger than the radius r2. That is, the opening 523 is provided on the inner side of the wavelength converter 53 when viewed from the +Z direction.

### Configuration of the Reflecting Part

The reflecting part 54 is disposed between the rotating plate 52 and the wavelength converter 53. The reflecting part 54 reflects light made incident from the wavelength converter 53 to the wavelength converter 53 side.

The reflecting part 54 can be configured as a reflective layer provided on the first surface 521 or the wavelength converter 53. In this case, the reflecting part 54 may be a reflective layer provided on substantially the entire first surface 521.

Besides, when the first surface 521 has sufficiently high light reflectivity, the first surface 521 can be adopted as the reflecting part 54.

### Configuration of the Driving Device

The driving device 55 is coupled to the rotating plate 52 of the phosphor wheel 51 and rotates the phosphor wheel 51. The driving device 55 is disposed in the −Z direction with respect to the phosphor wheel 51.

As illustrated in FIGS. 4 and 6, the driving device 55 includes the driving source 56 and the rotating body 57.

### Configuration of the Driving Source

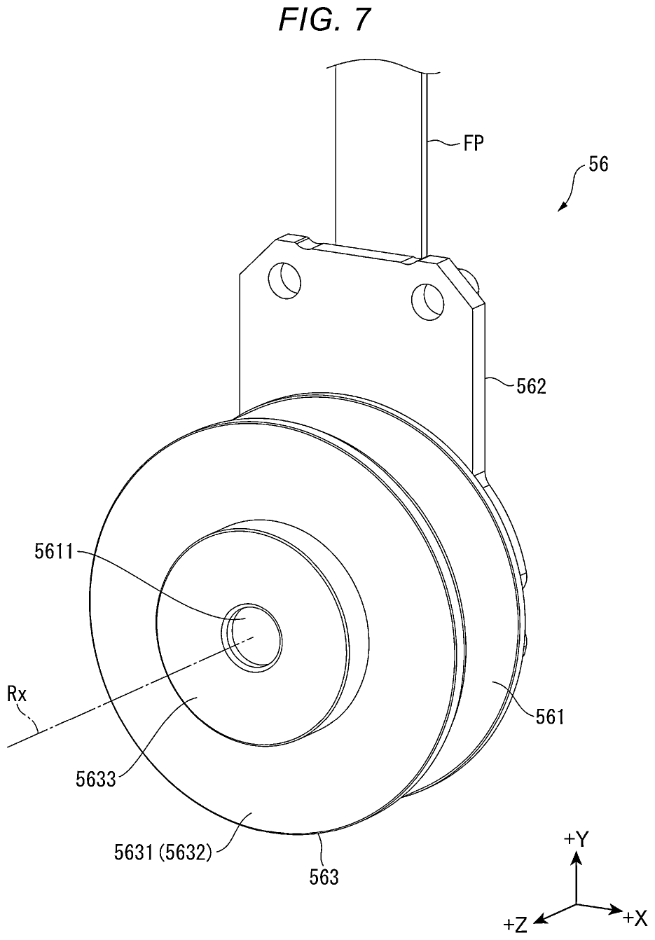

FIG. 7 is a perspective view illustrating the driving source 56 viewed from the +Z direction.

As illustrated in FIGS. 4, 6, and 7, the driving source 56 includes the motor 561, a support substrate 562, and a hub 563.

As illustrated in FIG. 7, the motor 561 includes a rotor 5611 and a not-illustrated stator that rotates the rotor 5611. The motor 561 is controlled by a control circuit 5621 of the support substrate 562 and rotates the rotor 5611 with the stator.

The support substrate 562 supports the motor 561. As illustrated in FIGS. 4 and 6, the support substrate 562 includes the control circuit 5621. The control circuit 5621 is coupled to the control device explained above via a flexible printed circuit board FP. The control circuit 5621 drives the motor 561 according to an electric signal input via the flexible printed circuit board FP.

As illustrated in FIG. 7, the hub 563 is disposed in the +Z direction with respect to the motor 561. The hub 563 is fixed to the rotor 5611 and is rotated centering on the rotation axis Rx together with the rotor 5611 by the motor 561. The hub 563 includes a main body 5631 and a fitting part 5633.

The main body 5631 is a main body portion of the hub 563. The main body 5631 is formed in a circular shape when viewed from the +Z direction. The outer diameter of the main body 5631 is substantially the same as the outer diameter of the motor 561 when viewed from the +Z direction. In the main body 5631, a surface in the +Z direction is a fixing surface 5632 that faces the rotating body 57 and to which the rotating body 57 is fixed by an adhesive or the like.

The fitting part 5633 is formed in a cylindrical shape centered on the rotation axis Rx and protrudes from the fixing surface 5632 in the +Z direction. The fitting part 5633 is inserted into a fitting hole 572 explained below of the rotating body 57 from the −Z direction and is fitted to the rotating body 57.

### Configuration of the Rotating Body

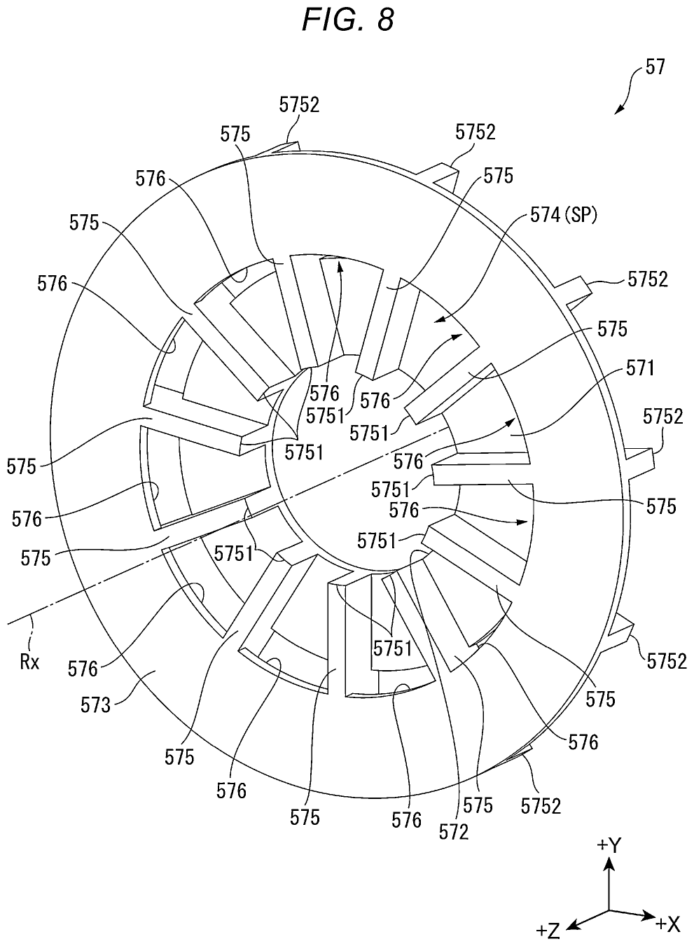

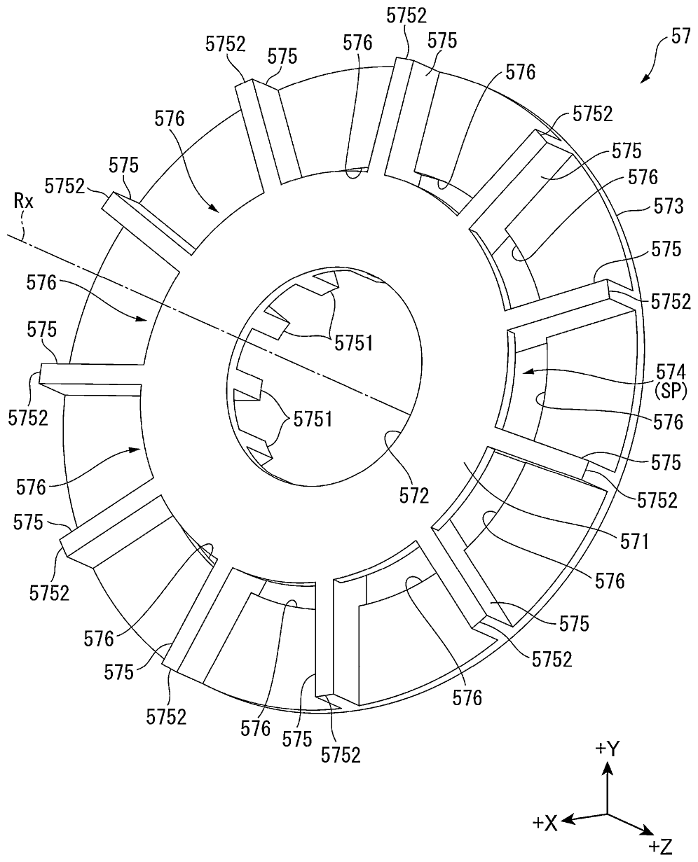

FIGS. 8 and 9 are perspective views illustrating the rotating body 57. Specifically, FIG. 8 is a perspective view illustrating the rotating body 57 viewed from the +Z direction. FIG. 9 is a perspective view illustrating the rotating body 57 viewed from the −Z direction.

The rotating body 57 is fixed to the hub 563 of the driving source 56 and is rotated centering on the rotation axis Rx by the driving source 56. As illustrated in FIG. 3, the rotating body 57 is coupled to the rotating plate 52 of the phosphor wheel 51 and rotates the rotating plate 52. In other words, the rotating body 57 rotates integrally with the rotating plate 52. As illustrated in FIGS. 8 and 9, the rotating body 57 includes a fixing part 571, a fitting hole 572, a coupling part 573, a suction part 574, a plurality of fins 575, and a plurality of flow paths 576.

### Configuration of the Fixing Part and the Fitting Hole

The fixing part 571 is a ring-like portion fixed to the main body 5631 of the hub 563 in the rotating body 57. When viewed from the +Z direction, the outer diameter of the fixing part 571 centered on the rotation axis Rx is substantially the same as the outer diameter of the hub 563 centered on the rotation axis Rx.

The fitting hole 572 is a hole formed in a circular shape centered on the rotation axis Rx in the fixing part 571 and penetrating the fixing part 571 along the rotation axis Rx.

In a state in which the fitting part 5633 of the hub 563 is inserted into the fitting hole 572, the surface in the −Z direction in the fixing part 571 is fixed to the fixing surface 5632 of the main body 5631 by an adhesive or the like, whereby the rotating body 57 is fixed to the hub 563.

### Configuration of the Coupling Part

The coupling part 573 is provided to be separated from the fixing part 571 in the +Z direction with respect to the fixing part 571 in the rotating body 57. The coupling part 573 is a ring-like portion coupled to the rotating plate 52. The outer diameter of the coupling part 573 centered on the rotation axis Rx is larger than the outer diameter of the fixing part 571 centered on the rotation axis Rx. The inner diameter of the coupling part 573 centered on the rotation axis Rx is larger than the inner diameter of the opening 523 centered on the rotation axis Rx. That is, the coupling part 573 is coupled to the outer side of the opening 523 on the second surface 522 of the rotating plate 52.

The surface in the +Z direction in the coupling part 573 is fixed to the second surface 522 of the rotating plate 52 by an adhesive or the like, whereby the rotating plate 52 and the rotating body 57 are integrated.

### Configuration of the Suction Part

The suction part 574 is configured by combining the rotating plate 52 and the rotating body 57 coupled to the hub 563 and is provided on a side opposite to the driving source 56 with respect to the rotating plate 52, that is, on the inner side of the opening 523 when viewed from the +Z direction. When viewed from the +Z direction, the rotation axis Rx is included in the inside of the opening 523 and the suction part 574.

The suction part 574 is a concave part opened in the +Z direction via the opening 523. The bottom of the suction part 574 includes the fitting part 5633 of the hub 563 and the fixing part 571. A part of the inner side surface of the suction part 574 includes a plurality of fins 575.

As explained in detail below, when the rotating plate 52 and the rotating body 57 rotate, a space in the suction part 574 has negative pressure because of the plurality of fins 575 rotating centering on the rotation axis Rx. Therefore, an air flow flows into the suction part 574 from a space in the +Z direction with respect to the rotating plate 52 via the opening 523. That is, the space in the suction part 574 is a suction space SP in which the air flow is sucked from the space in the +Z direction with respect to the rotating plate 52 by the plurality of fins 575 via the opening 523. The wavelength conversion device 5 has the suction space SP. In other words, the suction space SP in the suction part 574 can be considered a negative pressure generation space in which negative pressure is generated when the rotating plate 52 and the rotating body 57 rotate.

### Configuration of the Plurality of Fins

The plurality of fins 575 respectively extend from a portion on the rotation axis Rx side toward the outer side of the rotating plate 52 and are disposed side by side around the suction part 574. In other words, the plurality of fins 575 are disposed around the suction part 574 side by side at equal intervals in the circumferential direction centered on the rotation axis Rx. Specifically, the plurality of fins 575 respectively extend from the portion on the rotation axis Rx side toward the outer side of the rotating plate 52 and are disposed around the suction part 574 side by side in the circumferential direction centered on the rotation axis Rx. The plurality of fins 575 are rotated together with the rotating plate 52 by the driving source 56.

The plurality of fins 575 couple the fixing part 571 fixed to the hub 563 and the coupling part 573 coupled to the second surface 522 of the rotating plate 52. That is, the hub 563 of the driving source 56 and the rotating plate 52 are coupled via the plurality of fins 575. In other words, the rotating plate 52 and the driving source 56 are coupled via the plurality of fins 575.

Each of the plurality of fins 575 explained above extends from the peripheral edge of the fitting hole 572 to the peripheral edge of the coupling part 573 in a radial shape centered on the rotation axis Rx.

Each of the plurality of fins 575 includes a first end portion 5751 on the rotation axis Rx side and a second end portion 5752 on a side opposite to the rotation axis Rx.

As illustrated in FIGS. 3 and 5, the first end portion 5751 is disposed on the inner side of the opening 523 of the rotating plate 52 when the rotating body 57 is viewed from the +Z direction. Specifically, the first end portion 5751 is disposed on the inner side of the suction part 574 or the inside of the suction part 574 in the radial direction of the rotating plate 52.

As illustrated in FIGS. 4, 6, and 8, the second end portion 5752 is disposed at the peripheral edge of the coupling part 573.

Each of the plurality of fins 575 linearly extends in a radial shape centered on the rotation axis Rx. However, not only this, but the fin 575 may linearly extend in a rotating direction of the rotating body 57 or a direction opposite to the rotating direction of the rotating body 57 as the fin 575 is further separated from the rotation axis Rx. Each of the plurality of fins 575 may extend in a curved shape. In this case, for example, the fin 575 may extend in a curved shape in the rotating direction of the rotating body 57 or the direction opposite to the rotating direction of the rotating body 57 as the fin 575 is further separated from the rotation axis Rx. Further, each of the plurality of fins 575 may be present at a position where an extension line on the rotation axis Rx side deviates from the rotation axis Rx. That is, extension lines of the fins 575 extending to the rotation axis Rx side may not intersect the rotation axis Rx.

In the present embodiment, the number of fins 575 is eleven. That is, the fins 575 are provided substantially at every 32.7° centered on the rotation axis Rx. However, not only this, but the number of fins 575 can be changed as appropriate.

### Configuration of the Plurality of Flow Paths

The plurality of flow paths 576 are formed by a plurality of holes provided among the plurality of fins 575 in the rotating body 57. Specifically, each of the plurality of flow paths 576 is formed by a hole provided between two fins 575 adjacent to each other among the plurality of fins 575 and penetrating the rotating body 57 in a direction intersecting the rotation axis Rx. For this reason, the plurality of flow paths 576 cause the suction space SP in the suction part 574 and a space on the outer side of the rotating body 57 with respect to the rotation axis Rx to communicate.

As explained in detail below, the plurality of flow paths 576 are flow paths for causing an air flow flowing into the suction space SP on the inside of the suction part 574 via the opening 523 to flow to the outside of the rotating body 57 when the rotating plate 52 and the rotating body 57 rotate. The air flow having flowed through the plurality of flow paths 576 flows along the second surface 522 of the rotating plate 52.

### Configuration of a Housing Chamber of the Light Source Housing

As illustrated in FIG. 2, the light source housing 31 includes an emitting part 311 that emits the illumination light LT.

That is, the light source housing 31 includes the emitting part 311 that emits converted light obtained by converting excitation with light the wavelength conversion device 5.

Besides, the light source housing 31 includes a peripheral wall 312 surrounding the periphery of the wavelength conversion device 5 when viewed from the +Z direction and a closing wall 313 substantially orthogonal to the rotation axis Rx and closing the peripheral wall 312. The peripheral wall 312 and the closing wall 313 form a housing chamber 314 in which the wavelength conversion device 5 is housed. That is, the light source housing 31 includes the housing chamber 314 in which the wavelength conversion device 5 is disposed.

In the housing chamber 314, the wavelength conversion device 5 is disposed such that the driving device 55 is disposed between the closing wall 313 and the rotating plate 52.

Air Flow at the Time when the Phosphor Wheel Rotates

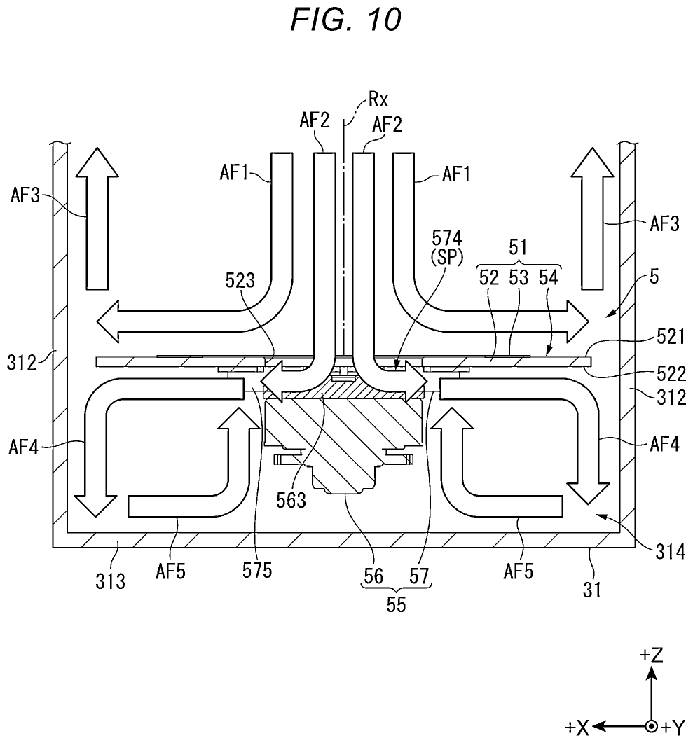

FIG. 10 is a schematic diagram illustrating an air flow flowing to the wavelength conversion device 5 when the phosphor wheel 51 rotates.

As explained above, when the rotating body 57 is rotated centering on the rotation axis Rx by the driving source 56, the rotating plate 52 coupled to the rotating body 57 rotates in one direction centering on the rotation axis Rx.

When the rotating plate 52 and the rotating body 57 are rotated, the suction space SP in the suction part 574 has negative pressure. For this reason, as illustrated in FIG. 10, an air flow flowing from a space on the side opposite to the driving source 56 with respect to the rotating plate 52 to the rotating plate 52 is generated. That is, on the inside of the light source housing 31, air flows AF1 and AF2 flowing from the space in the +Z direction with respect to the rotating plate 52 to the rotating plate 52 are generated.

Of the air flows AF1 and AF2 flowing to the rotating plate 52, the air flow AF1 collides with the first surface 521 of the rotating plate 52 and flows toward the outer side in the radial direction of the first surface 521 along the first surface 521. The wavelength converter 53 provided on the first surface 521 of the rotating plate 52 and the first surface 521 of the rotating plate 52 to which heat is transferred from the wavelength converter 53 are cooled by a part of the air flow AF1 explained above.

The air flow AF1 having flowed toward the outer side in the radial direction of the first surface 521 along the first surface 521 collides with the peripheral wall 312 and flows in the +Z direction as an air flow AF3 along the peripheral wall 312. As explained above, on the inside of the light source housing 31, gas in the space in the +Z direction with respect to the rotating plate 52 is agitated to circulate when the rotating plate 52 and the rotating body 57 are rotated.

A part of the air flow colliding with the peripheral wall 312 flows in the −Z direction with respect to the rotating plate 52, that is, to the driving source 56 side. However, a part of the air flow explained above collides with the air flow about to flow in the +Z direction in the air flow flowing along the second surface 522 and colliding with the peripheral wall 312. Accordingly, substantially the entire air flow AF1 having flowed along the first surface 521 flows to the space in the +Z direction with respect to the rotating plate 52.

A part of the suction part 574 includes the rotating body 57. Since the rotating body 57 is provided in the rotor 5611 of the driving source 56, the heat of the driving source 56 is transferred to the rotating body 57.

On the other hand, of the air flows AF1 and AF2 flowing toward the rotating plate 52, the air flow AF2 flows into the suction space SP in the suction part 574 via the opening 523 of the rotating plate 52. The rotating body 57 is cooled and the driving source 56 is also cooled by the air flow AF2 explained above flowing to the suction space SP.

The air flow AF2 flowing into the suction space SP in the suction part 574 is discharged to the outside of the rotating body 57 centered on the rotation axis Rx through the plurality of flow paths 576 by the rotation of the plurality of fins 575. The air flow AF2 discharged to the outside of the rotating body 57 changes to an air flow AF4 and flows along the second surface 522. Accordingly, the second surface 522 of the rotating plate 52 to which the heat of the wavelength converter 53 is transferred is cooled.

Further, the air flow AF4 flowing along the second surface 522 toward the outer side in the radial direction of the second surface 522 pulls gas in the space on the driving source 56 side with respect to the rotating plate 52 and generates an air flow AF5 flowing from the driving source 56 side toward the second surface 522. The air flow AF5 flowing toward the second surface 522 flows along the driving source 56 and cools the driving source 56.

Note that the air flow AF4 having flowed to the outer side in the radial direction of the second surface 522 along the second surface 522 collides with the peripheral wall 312. Although not illustrated, a part of the air flow AF4 colliding with the peripheral wall 312 flows in the +Z direction with respect to the rotating plate 52.

The other air flow in the air flow AF4 colliding with the peripheral wall 312 collides with the peripheral wall 312 and thereafter flows in the −Z direction and flows to the driving source 56 side along the closing wall 313. The air flow AF5 having flowed to the driving source 56 side is sucked by the rotating plurality of fins 575 again and flows along the driving source 56. In this way, a part of the air flows AF4 and AF5 in a space surrounded by the peripheral wall 312, the closing wall 313, and the rotating plate 52 circulates in the space to cool the second surface 522 of the rotating plate 52 and the driving source 56.

Further, according to the generation of the air flows AF1 and AF2 flowing toward the rotating plate 52, an air flow flows to the first condenser 37, which is the pickup optical system, illustrated in FIG. 2. In the first condenser 37, a calorific value of the lenses 371, 372, and 373 is increased by the blue light BLs made incident on the wavelength converter 53 and the fluorescent light YL emitted from the wavelength converter 53. The increase in the calorific value affects the optical performance of the lenses. In contrast, in the light source device 3 according to the present embodiment, since heat generated in the lenses 371, 372, and 373 of the first condenser 37 is easily radiated to the air flows AF1 and AF2, the lenses 371, 372, and 373 can be effectively cooled and deterioration in the optical performance of the first condenser 37 can be suppressed.

Here, the light source housing 31 is formed of a material having high thermal conductivity. The heat in the light source housing 31 is transferred to the light source housing 31 and radiated to the outside of the light source housing 31.

For this reason, a heat radiation member that radiates heat received from the space in the light source housing 31 may be provided in, for example, at least one of the peripheral wall 312 and the closing wall 313. Further, a circulation device that circulates cooling fluid to the heat radiation member may be provided.

### Effects of the First Embodiment

The projector 1 according to the present embodiment explained above achieves the following effects.

The projector 1 includes the light source device 3, the image forming device 24 that modulates light emitted from the light source device 3 to form image light, and the projection optical device 26 that projects the image light formed by the image forming device 24.

The light source device 3 includes the wavelength conversion device 5, the light source housing 31 that houses the wavelength conversion device 5, and the light source 32 that emits the blue light BLs made incident on the wavelength conversion device 5. The light source housing 31 is equivalent to the case in the present disclosure, and the blue light BLs is equivalent to the excitation light.

The light source housing 31 includes the emitting part 311 that emits, to the outside, the fluorescent light YL, which is the converted light, emitted from the wavelength conversion device 5.

The wavelength conversion device 5 includes the rotating plate 52, the wavelength converter 53, the driving source 56, the rotating body 57, the suction part 574, the plurality of fins 575, and the plurality of flow paths 576.

The rotating plate 52 has the first surface 521, the second surface 522 on the side opposite to the first surface 521, and the opening 523 penetrating the rotating plate 52 from the first surface 521 to the second surface 522. The first surface 521 is the surface on the side opposite to the driving source 56 and is the surface facing the +Z direction. The second surface 522 is the surface on the driving source 56 side and is the surface facing the −Z direction.

The wavelength converter 53 is disposed further on the outer side than the opening 523 in the radial direction of the rotating plate 52. The wavelength converter 53 emits the fluorescent light YL obtained by converting the wavelength of the blue light BLs made incident thereon.

The rotating body 57 is coupled to the second surface 522 of the rotating plate 52.

The driving source 56 rotates the rotating plate 52 and the rotating body 57 centering on the rotation axis Rx.

The suction part 574 is configured by combining the rotating plate 52 and the rotating body 57. The suction part 574 is provided on the inner side of the opening 523 when viewed from the side opposite to the driving source 56 with respect to the rotating plate 52. That is, the suction part 574 is provided on the inner side of the opening 523 when viewed from the +Z direction. The suction part 574 communicates with the space in the +Z direction with respect to the rotating plate 52 via the opening 523.

The plurality of fins 575 respectively extend from a portion on the rotation axis Rx side toward the outer side of the rotating plate 52 and are disposed side by side around the suction part 574. That is, the plurality of fins 575 respectively extend from the portion on the rotation axis Rx side toward the outer side of the rotating plate 52 and are disposed around the suction part 574 side by side in the circumferential direction centered on the rotation axis Rx. The plurality of fins 575 are rotated together with the rotating plate 52 by the driving source 56.

The plurality of flow paths 576 are provided among the plurality of fins 575. The plurality of flow paths 576 cause the air flow flowing to the inside of the suction part 574 via the opening 523 to flow to the outside of the rotating body 57.

With the configuration explained above, when the rotating plate 52 and the rotating body 57 are rotated by the driving source 56, the suction space SP in the suction part 574 has negative pressure with the plurality of fins 575 provided around the suction part 574. The air flows AF1 and AF2 flow from the space on the side opposite to the driving source 56 with respect to the rotating plate 52 toward the opening 523.

The air flow AF1 flowing to the opening 523 collides with the first surface 521 of the rotating plate 52, flows along the first surface 521, and cools the rotating plate 52.

On the other hand, the air flow AF2 flowing to the opening 523 flows into the suction part 574 via the opening 523. The air flow having flowed into the suction part 574 cools the driving source 56 via the rotating body 57.

Further, the plurality of fins 575 are rotated, whereby the air flow having flowed into the suction part 574 flows to the outside of the rotating body 57 through the plurality of flow paths 576. The air flow AF4 having flowed to the outside of the rotating body 57 flows along the second surface 522 of the rotating plate 52 to cool the rotating plate 52.

Here, the heat of the wavelength converter 53 provided in the rotating plate 52 is transferred to the entire rotating plate 52. For this reason, both the surfaces of the rotating plate 52 are cooled and the wavelength converter 53 is also cooled by the air flow AF1 flowing along the first surface 521 of the rotating plate 52 and the air flow AF4 flowing along the second surface 522 of the rotating plate 52.

Further, when the plurality of fins 575 rotate, the air flow AF5 also flows toward the rotating plate 52 from the space on the driving source 56 side with respect to the rotating plate 52. Since a part of the air flow AF5 explained above flows along the driving source 56, the driving source 56 is cooled by the part of the air flow AF5.

Besides, at least a part of the suction part 574 through which an air flow flows via the opening 523 includes the rotating body 57 coupling the driving source 56 and the rotating plate 52. The plurality of flow paths 576 for causing the air flow flowing to the inside of the suction part 574 to flow to the outer side of the rotating body 57 are provided around the suction part 574. For this reason, heat is less easily transferred from the rotating body 57 to the driving source 56. This makes it possible to suppress the heat of the rotating plate 52 on which the wavelength converter 53 is disposed from being transferred to the driving source 56.

As explained above, it is possible to prevent the heat of the wavelength converter 53 from being easily transferred to the driving source 56. Besides, it is possible to cool the driving source 56 and the rotating plate 52 and also cool the wavelength converter 53 with the air flow generated by the rotation of the plurality of fins 575. Accordingly, it is possible to improve the cooling efficiency of each of the driving source 56 and the wavelength converter 53.

In a general wavelength conversion device, in order to enhance the cooling effect of the wavelength converter, a rotating plate having a large diameter is adopted, and the wavelength converter is disposed on the peripheral edge side of the rotating plate. In contrast, the wavelength conversion device 5 according to the present embodiment can improve the cooling efficiency of the wavelength converter 53. Therefore, it is possible to effectively cool the wavelength converter 53 even if the rotating plate 52 is reduced in diameter. For this reason, by adopting the rotating plate 52 having a small diameter, a driving source having a low output can be adopted as the driving source 56 for driving the rotating plate 52. This makes it possible to reduce the wavelength conversion device 5 in size and reduce power consumption of the driving source 56.

In the light source device 3 including the light source housing 31 as the case for housing the wavelength conversion device 5, the air flow having flowed along the rotating plate 52 convectively flows in the light source housing 31 and thereafter flows again toward the suction part 574 according to the rotation of the plurality of fins 575. For this reason, the air flow in the light source housing 31 circulates. In this way, since the air flow flowing toward the suction part 574 is the air flow that has convectively flowed in the light source housing 31, it is possible to lower the temperature of the air flow flowing to the wavelength conversion device 5. Therefore, it is possible to improve the cooling efficiency of each of the wavelength converter 53 and the driving source 56.

Since the wavelength conversion device 5 is cooled by circulating the air flow in the light source housing 31, a sealed type case can be adopted as the light source housing 31 that houses the wavelength conversion device 5. In this case, it is possible to prevent dust from intruding into the light source housing 31 and prevent dust from adhering to the light source 32 and the wavelength conversion device 5.

As explained above, since the cooling efficiency of the wavelength conversion device 5 can be improved, it is possible to suppress deterioration in the image quality of a projected image. Besides, it is possible to achieve extension of the life of the projector 1.

In the wavelength conversion device 5, when viewed from the side opposite to the driving source 56 with respect to the rotating plate 52, the first end portion 5751 on the rotation axis Rx side in each of the plurality of fins 575 is disposed on the inside of the opening 523.

With the configuration explained above, with the rotating plurality of fins 575, it is possible to cause the air flow having flowed into the suction part 574 via the opening 523 to quickly flow to the outside of the rotating body 57. This makes it possible to increase a flow rate of the air flow flowing into the suction part 574 and increase a flow rate of the air flow flowing along the second surface 522 of the rotating plate 52. Therefore, it is possible to improve the cooling efficiency of each of the wavelength converter 53 and the driving source 56.

In the wavelength conversion device 5, the rotating plate 52 and the driving source 56 are coupled via the plurality of fins 575.

With the configuration explained above, it is possible to easily configure the suction part 574 around which the plurality of fins 575 are provided while reducing an interval between the rotating plate 52 and the driving source 56. Therefore, it is possible to reduce the wavelength conversion device 5 in size on the Z axis extending along the rotation axis Rx.

In the wavelength conversion device 5, the opening 523 overlaps the driving source 56 when viewed along the rotation axis Rx.

With the configuration explained above, it is possible to cause the air flow having flowed into the suction part 574 to easily flow to the rotating body 57 and flow to the hub 563 of the driving source 56 as well. Therefore, it is possible to improve the cooling efficiency of the driving source 56.

In the wavelength conversion device 5, the extension line of the rotation axis Rx passes through the opening 523.

With the configuration explained above, the opening 523 is disposed on the rotation axis Rx. For this reason, when the rotating plate 52 and the rotating body 57 rotate, the inside of the opening 523 can easily have negative pressure. It is possible to cause the air flow to easily flow into the suction part 574 via the opening 523. Therefore, since a flow rate of the air flow flowing to the rotating plate 52 and the rotating body 57 can be increased, it is possible to further improve the cooling efficiency of each of the wavelength converter 53 and the driving source 56.

Here, it is conceivable that the opening is formed in the rotating plate by punching. When a plurality of openings are provided in the rotating plate by the method explained above, the rotating plate is distorted, causing deformation of the wavelength converter and also causing damage to the wavelength converter. For this reason, it is necessary to examine a configuration for suppressing the deformation of the wavelength converter.

In contrast, since the opening 523 is disposed on the rotation axis Rx, one opening 523 is provided in the rotating plate 52. For this reason, it is possible to prevent distortion from occurring in the rotating plate 52 and prevent deformation and damage from occurring in the wavelength converter 53.

### Second Embodiment

Next, a second embodiment of the present disclosure is explained.

A projector according to the present embodiment includes the same components as the components of the projector 1 according to the first embodiment but is different in that the rotating plate includes a nozzle. In the following explanation, portions that are the same or substantially the same as the portions explained above are denoted by the same reference numerals and signs and explanation of the portions is omitted.

### Configurations of the Projector and a Light Source Device

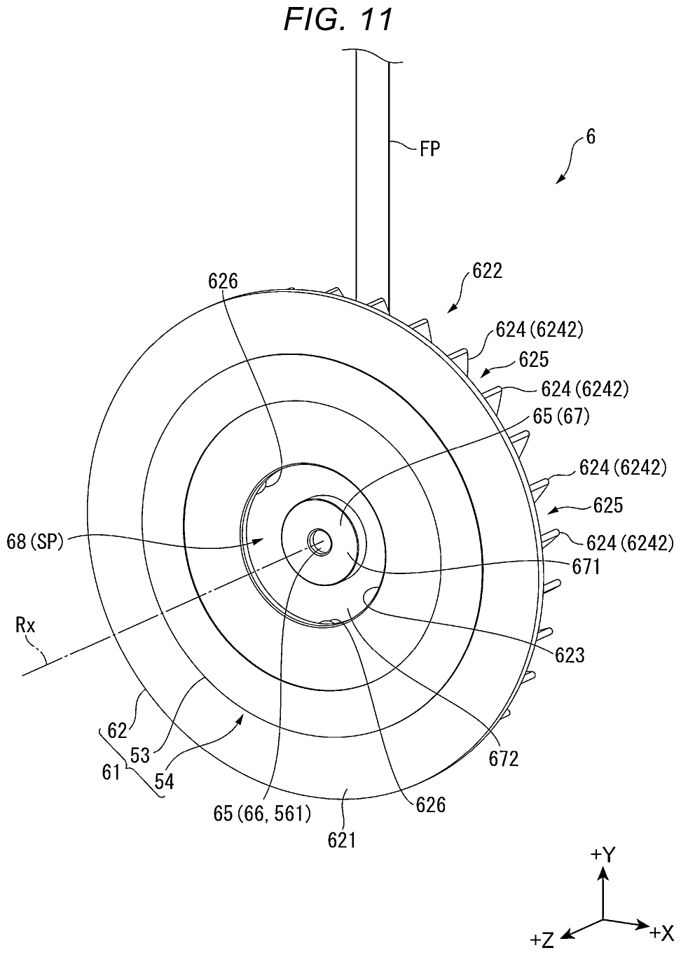

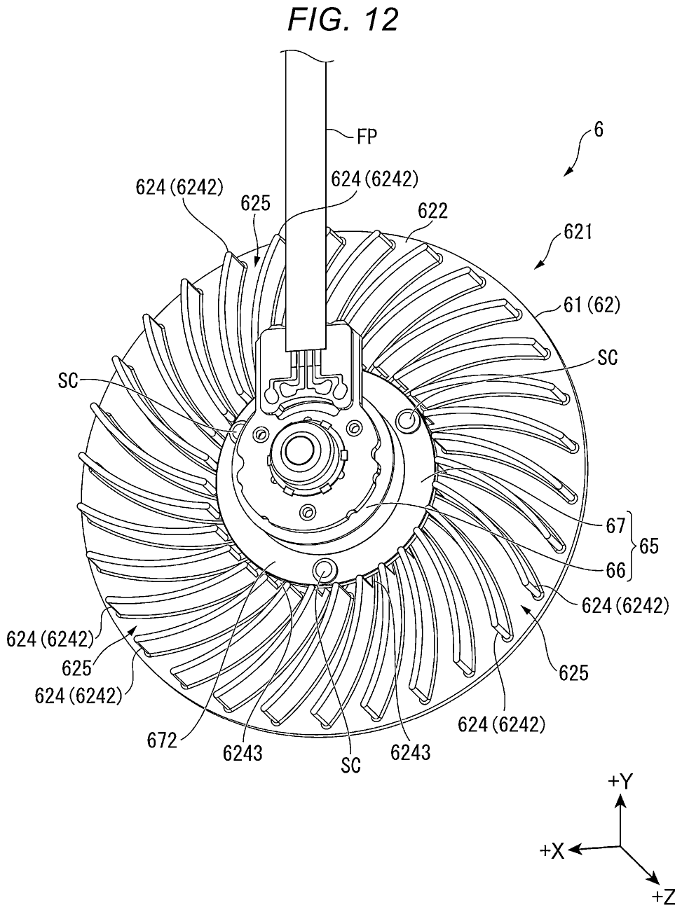

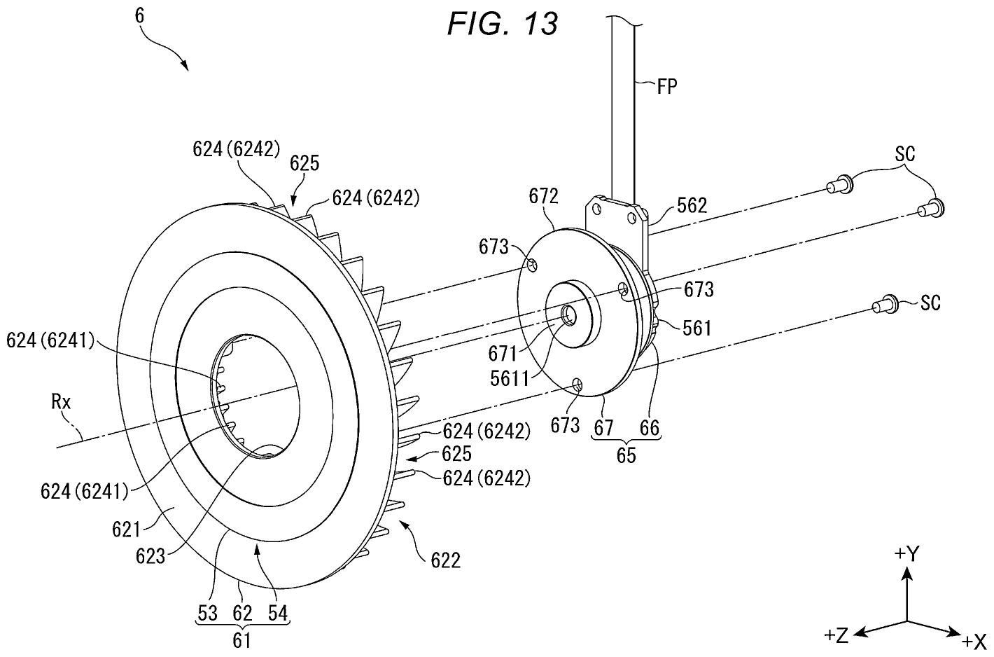

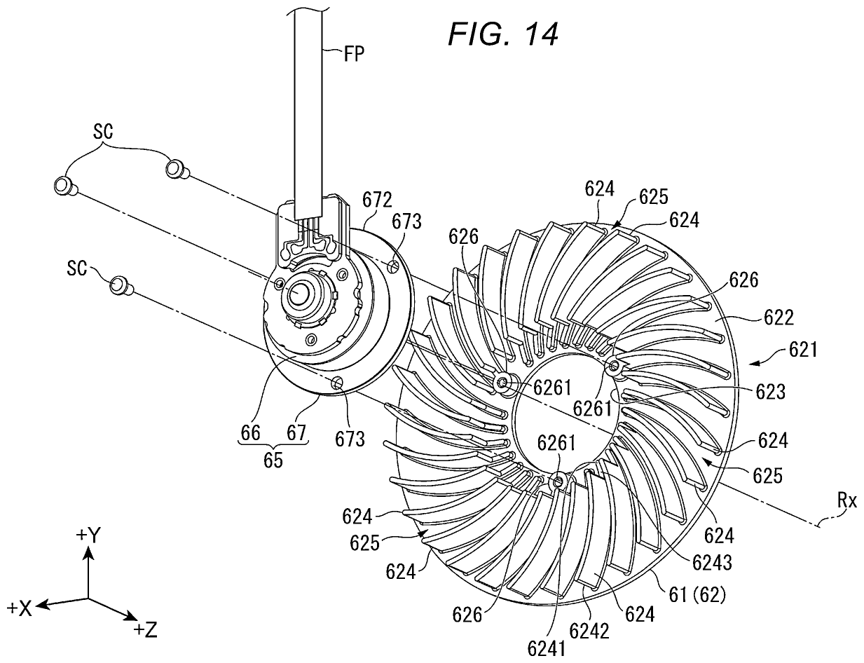

FIGS. 11 and 12 are perspective views illustrating a wavelength conversion device 6 of a light source device provided in the projector according to the present embodiment. FIG. 11 is a perspective view illustrating the wavelength conversion device 6 viewed from the +Z direction. FIG. 12 is a perspective view illustrating the wavelength conversion device 6 viewed from the −Z direction. FIG. 13 is an exploded perspective view illustrating the wavelength conversion device 6 viewed from the +Z direction. FIG. 14 is an exploded perspective view illustrating the wavelength conversion device 6 viewed from the −Z direction. In FIGS. 11 to 14, only some of a plurality of fins 624 are denoted by reference numerals and only some of a plurality of flow paths 625 are denoted by the reference numerals.

The projector according to the present embodiment includes same components and functions as the components and the functions of the projector 1 according to the first embodiment except that the projector includes the wavelength conversion device 6 illustrated in FIGS. 11 to 14 instead of the wavelength conversion device 5 according to the first embodiment. That is, the light source device according to the present embodiment includes same components and functions as the components and the functions of the light source device 3 according to the first embodiment except that the light source device includes the wavelength conversion device 6 instead of the wavelength conversion device 5.

### Configuration of the Wavelength Conversion Device

Like the wavelength conversion device 5, the wavelength conversion device 6 is housed in the light source housing 31 as a case and emits converted light obtained by converting the wavelength of excitation light made incident thereon. Specifically, the wavelength conversion device 6 emits the fluorescent light YL having a wavelength longer than the wavelength of the blue light BLs made incident thereon. The wavelength conversion device 6 includes a phosphor wheel 61, a driving device 65, and a suction part 68.

The phosphor wheel 61 includes same components and functions as the components and the functions of the phosphor wheel 51 according to the first embodiment except that the phosphor wheel 61 includes a rotating plate 62 instead of the rotating plate 52. That is, the phosphor wheel 61 includes a rotating plate 62, the wavelength converter 53, and the reflecting part 54.

The driving device 65 includes a driving source 66 and a rotating body 67.

The suction part 68 is configured by combining the rotating plate 62 and the rotating body 67.

A configuration of the wavelength conversion device 6 is explained below.

### Configuration of the Driving Device

First, the driving device 65 is explained.

Like the driving device 55 according to the first embodiment, the driving device 65 rotates the phosphor wheel 61 centering on the rotation axis Rx. As illustrated in FIGS. 12 to 14, the driving device 65 includes the driving source 66 and the rotating body 67.

The driving source 66 includes same components and functions as the components and the functions of the driving source 56 according to the first embodiment except that the driving source 66 does not include the hub 563. That is, as illustrated in FIG. 13, the driving source 66 includes the motor 561 and the support substrate 562.

The rotating body 67 is a hub provided in the driving source 66 instead of the hub 563 according to the first embodiment and is fixed to the rotor 5611 of the motor 561 as illustrated in FIGS. 11 and 13. The rotating body 67 is coupled to the driving source 66 and the rotating plate 62 and is rotated together with the rotating plate 62 by the driving source 66. The rotating body 67 is disposed in the +Z direction with respect to the motor 561. The rotating body 67 includes a columnar part 671 and a flange 672.

The columnar part 671 is a portion protruding in the +Z direction in a cylindrical shape centering on the rotation axis Rx.

The flange 672 is equivalent to the engaging part in the present disclosure. The flange 672 is a portion disposed on the outer side with respect to the columnar part 671 and is a portion formed in a disk shape centered on the rotation axis Rx. The flange 672 engages with a protrusion 626 of the rotating plate 62 explained below. Specifically, the flange 672 is in contact with an end portion in the −Z direction in the protrusion 626.

When viewed from the +Z direction, the outer diameter of the flange 672 is larger than the outer diameter of the motor 561. A plurality of insertion holes 673 penetrating the flange 672 along the rotation axis Rx are provided at the peripheral edge of the flange 672.

The plurality of insertion holes 673 are provided at equal intervals in the circumferential direction centered on the rotation axis Rx. Specifically, each of the plurality of insertion holes 673 is provided at a position corresponding to the protrusion 626 in the flange 672. Screws SC for coupling the rotating plate 62 to the rotating body 67 are inserted through the insertion holes 673 in the +Z direction. The screws SC inserted through the insertion holes 673 are fixed to the protrusion 626, whereby the rotating body 67 and the rotating plate 62 are coupled.

### Configuration of the Rotating Plate

Like the rotating plate 52 according to the first embodiment, the rotating plate 62 supports the wavelength converter 53 and the reflecting part 54. The rotating plate 62 is rotated centering on the rotation axis Rx by the driving device 65 including the rotating body 67 coupled to the rotating plate 62. The rotating plate 62 is formed in a disk shape centered on the rotation axis Rx and is made of, for example, metal. As illustrated in FIGS. 11 to 14, the rotating plate 62 has a first surface 621, a second surface 622, and an opening 623.

The first surface 621 is a surface facing the +Z direction.

The second surface 622 is a surface on a side opposite to the first surface 621 and faces the −Z direction.

The opening 623 penetrates the rotating plate 62 from the first surface 621 to the second surface 622 along the rotation axis Rx. The opening 623 is formed in a circular shape when viewed from the +Z direction, which is an incident side of excitation light. As explained in detail below, when the rotating plate 62 rotates, an air flow flows from a space in the +Z direction with respect to the rotating plate 62 to the suction part 68 via the opening 623.

### Configuration of a Plurality of Protrusions

Besides including the plurality of fins 624 and the plurality of flow paths 625 as illustrated in FIGS. 12 and 14, the rotating plate 62 further includes a plurality of protrusions 626 as illustrated in FIG. 14.

The plurality of protrusions 626 are provided at equal intervals in the circumferential direction centered on the rotation axis Rx at positions in the vicinity of the peripheral edge of the opening 623 on the outer side of the opening 623 in the radial direction of the second surface 622. That is, each of the plurality of protrusions 626 protrudes in the −Z direction from the second surface 622 toward the rotating body 67. Each of the plurality of protrusions 626 has a screw hole 6261 into which the screw SC is inserted in the +Z direction. The screw SC inserted through the insertion hole 673 of the rotating body 67 in the +Z direction is inserted into the screw hole 6261 explained above and the screw SC is fixed to the protrusion 626, whereby the rotating plate 62 and the rotating body 67 are coupled.

### Configuration of the Plurality of Fins

The plurality of fins 624 are provided on the second surface 622 facing the driving source 66 in the rotating plate 62. As illustrated in FIG. 14, the plurality of fins 624 respectively extend from a portion on the rotation axis Rx side toward the outer side of the rotating plate 62 and are disposed side by side around the suction part 68 explained below. In other words, the plurality of fins 624 are disposed around the suction part 68 side by side at equal intervals in the circumferential direction centered on the rotation axis Rx. Specifically, the plurality of fins 624 respectively extend from the portion on the rotation axis Rx side toward the outer side of the rotating plate 62 and are disposed around the suction part 68 side by side along the circumferential direction centered on the rotation axis Rx. The plurality of fins 624 are rotated together with the rotating plate 62 by the driving source 66.

Each of the plurality of fins 624 includes a first end portion 6241, a second end portion 6242, and a coupling part 6243.

The first end portion 6241 is disposed on the outer side of the opening 623 or the outside of the opening 623 in the radial direction of the rotating plate 62 and at a position in the vicinity of the peripheral edge of the opening 623.

The second end portion 6242 is disposed at the edge portion on a side opposite to the rotation axis Rx in the rotating plate 62. That is, the second end portion 6242 is disposed at the peripheral edge on the second surface 622 of the rotating plate 62.

The coupling part 6243 is a step portion provided in a portion on the rotation axis Rx side in the fin 624. Specifically, the coupling part 6243 is provided in a portion on the rotation axis Rx side including the first end portion 6241 in the fin 624. The coupling part 6243 is a portion in which a protrusion dimension in the −Z direction from the second surface 622 is smaller than a protrusion dimension of the other portion in the fin 624. When the rotating plate 62 and the rotating body 67 are coupled, a surface in the +Z direction in the flange 672 of the rotating body 67 comes into contact with the coupling part 6243. That is, the rotating plate 62 and the rotating body 67 are coupled via the coupling part 6243 of the fins 624. The coupling part 6243 may not necessarily be the step portion. That is, the surfaces facing the rotating body 67 in the fins 624 only have to function as the coupling part 6243 to be coupled to the flange 672 of the rotating body 67. On the other hand, each of the plurality of fins 624 may not be in contact with the rotating body 67. In other words, the coupling part 6243 may be absent in the fin 624.

As explained in detail below, when the rotating plate 62 and the rotating body 67 are coupled to each other, the suction part 68 is provided between the second surface 622 and the surface in the +Z direction surface in the flange 672.

In the present embodiment, the fins 624 extend in a curved shape to be located in a direction opposite to a rotating direction of the rotating plate 62 from the first end portion 6241 toward the outer side of the rotating plate 62.

However, not only this, but the fins 624 may extend in a curved shape to be located in the rotating direction of the rotating plate 62 from the first end portion 6241 toward the outer side of the rotating plate 62. Further, the fins 624 may extend in a linear shape like the fins 575 according to the first embodiment. In this case, the fins 624 may extend in a radial shape centered on the rotation axis Rx or may extend in a linear shape to be located in the rotating direction of the rotating plate 62 or in a direction opposite to the rotating direction of the rotating plate 62 from the first end portion 6241 toward the outer side of the rotating plate 62. Further, the fins 624 may be present at positions where extension lines on the rotation axis Rx side deviate from the rotation axis Rx. That is, the extension lines of the fins 624 extending to the rotation axis Rx side may not intersect the rotation axis Rx.

### Configuration of the Plurality of Flow Paths

The plurality of flow paths 625 are provided among the plurality of fins 624. Specifically, each of the plurality of flow paths 625 is provided between two fins 624 adjacent to each other among the plurality of fins 624. Each of the plurality of flow paths 625 is a flow path for causing an air flow having flowed to the inside of the suction part 68 explained below via the opening 623 to flow to the outside of the rotating body 67.

### Configuration of the Suction Part

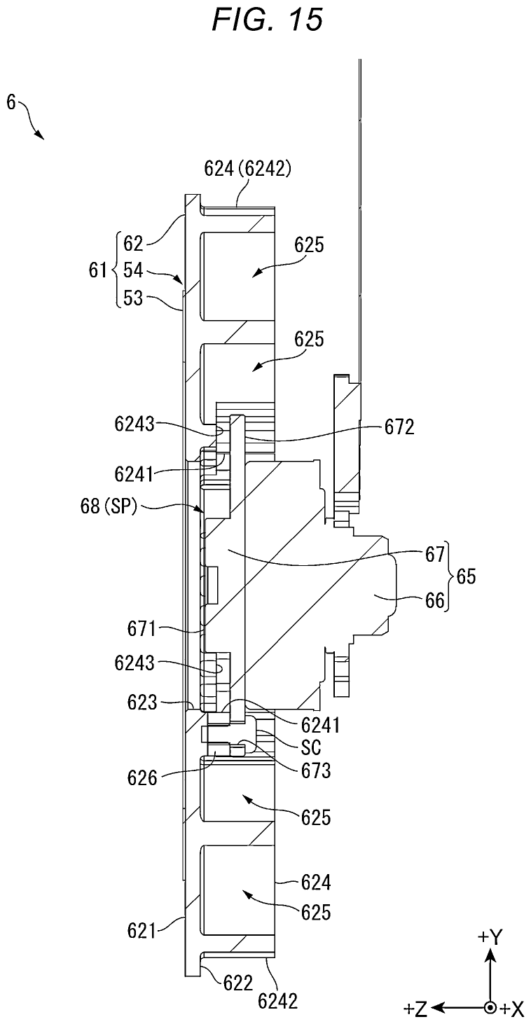

FIG. 15 is a diagram illustrating a cross section of the wavelength conversion device 6 along a YZ plane.

The suction part 68 is a portion configured when the rotating plate 62 and the rotating body 67 are combined in the wavelength conversion device 6. The suction part 68 is provided on the inner side of the opening 623 when viewed from the +Z direction as illustrated in FIG. 11 and is a portion between the rotating plate 62 and the rotating body 67 as illustrated in FIG. 15. That is, the suction part 68 is provided on a side opposite to the driving source 66 with respect to the rotating body 67, that is, the inner side of the opening 623 when viewed from the +Z direction and communicates with the space in the +Z direction with respect to the rotating plate 62 via the opening 623. Specifically, the suction part 68 is a gap portion formed between the second surface 622 of the rotating plate 62 and the surface facing the +Z direction of the rotating body 67 when coupling parts 6243 and the protrusions 626 of the plurality of fins 624 and the flange 672 of the rotating body 67 come into contact.

A space in the suction part 68 is the suction space SP that, when the rotating plate 62 and the rotating body 67 rotate, has negative pressure with the plurality of fins 624 provided in the rotating plate 62 to suck an air flow from the space in the +Z direction with respect to the rotating plate 62 via the opening 623. That is, the suction space SP in the suction part 68 can be considered a negative pressure generation space in which negative pressure is generated when the rotating plate 62 and the rotating body 67 rotate.

The air flow flowing into the suction space SP is sucked by the rotating plurality of fins 624 and flows from the peripheral edge of the opening 623 toward the outer peripheral edge of the rotating plate 62 through the plurality of flow paths 625 provided among the plurality of fins 624.

Air Flow at the Time when the Phosphor Wheel Rotates

Although not illustrated, a flow of an air flow at the time when the phosphor wheel 61 is rotated by the driving device 65 is the same as the flow in the wavelength conversion device 5 according to the first embodiment.

That is, when the rotating plate 62 and the rotating body 67 are rotated centering on the rotation axis Rx, the suction space SP in the suction part 68 has negative pressure. For this reason, an air flow flowing from the space in the +Z direction with respect to the rotating plate 62 toward the rotating plate 62 is generated in the light source housing 31.

Like the air flow AF1 illustrated in FIG. 10, a part of the air flow flowing toward the rotating plate 62 collides with the first surface 621 of the rotating plate 62 and flows to the outer side in the radial direction of the first surface 621 along the first surface 621. The wavelength converter 53 provided on the first surface 621 and the first surface 621 to which heat is transferred from the wavelength converter 53 are cooled by the air flow explained above. The air flow having flowed toward the outer side in the radial direction of the first surface 621 flows in the +Z direction along the peripheral wall 312, convectively flows on the inside of the light source housing 31, and flows toward the rotating plate 62 again. That is, gas in the space in the +Z direction with respect to the rotating plate 62 in the light source housing 31 is agitated to circulate when the rotating plate 62 and the rotating body 67 rotate. At this time, at least a part of the air flow convectively flowing on the inside of the light source housing 31 and flowing toward the rotating plate 62 flows, for example, along the first condenser 37 and cools the first condenser 37.

A part of the air flow flowing toward the rotating plate 62 flows into the suction space SP in the suction part 68 via the opening 623. The rotating body 67 is cooled and the driving source 66 is also cooled by the air flow flowing to the suction space SP explained above.

The air flow flowing into the suction space SP is discharged to the outside of the rotating body 67 through the plurality of flow paths 625 by the rotation of the plurality of fins 624. The air flow discharged to the outside of the rotating body 67 further passes through the plurality of flow paths 625 and flows along the second surface 622. Accordingly, the second surface 622 to which the heat of the wavelength converter 53 is transferred is cooled.

Further, gas in the space on the driving source 66 side with respect to the rotating plate 62 is pulled by the air flow flowing to the outer side in the radial direction of the second surface 522 along the second surface 622 and an air flow flowing from the driving source 66 side toward the second surface 622 is generated. The driving source 66 is cooled by the air flow explained above.

A part of the air flow having flowed to the outer side in the radial direction of the second surface 622 along the second surface 622 collides with the peripheral wall 312 and thereafter flows in the −Z direction with respect to the rotating plate 62. The air flow explained above flows to the driving source 66 side along the closing wall 313, is sucked by the plurality of rotating fins 624 again, and flows along the driving source 66. As explained above, gas in the space surrounded by the peripheral wall 312, the closing wall 313, and the rotating plate 62 circulates in the space and cools the second surface 622 of the rotating plate 62 and the driving source 66.

As explained above, for example, a heat radiation member that radiates heat received from the space in the light source housing 31 may be provided in at least one of the peripheral wall 312 and the closing wall 313. Further, a circulation device that circulates cooling fluid to the heat radiation member may be provided.

### Effects of the Second Embodiment

The projector according to the present embodiment explained above achieves the following effects besides achieving the same effects as the effects of the projector 1 according to the first embodiment.

For example, the projector according to the present embodiment includes the light source device having same components and functions as the components and the functions of the light source device 3, the image forming device 24, and the projection optical device 26. The light source device according to the present embodiment includes the wavelength conversion device 6, the light source housing 31, and the light source 32. The light source housing 31 functioning as the case includes the emitting part 311 that emits, to the outside, the fluorescent light YL, which is the converted light, emitted from the wavelength conversion device 6.

The wavelength conversion device 6 includes the rotating plate 62, the wavelength converter 53, the driving source 66, the rotating body 67, the suction part 68, the plurality of fins 624, and the plurality of flow paths 625.

The rotating plate 62 has the first surface 621, the second surface 622 on the side opposite to the first surface 621, and the opening 623 penetrating the rotating plate 62 from the first surface 621 to the second surface 622. The first surface 621 is the surface on the side opposite to the driving source 66 and is the surface facing the +Z direction. The second surface 622 is the surface on the driving source 66 side and is the surface facing the −Z direction.

The wavelength converter 53 is disposed further on the outer side than the opening 623 in the radial direction of the rotating plate 62. The wavelength converter 53 emits the fluorescent light YL obtained by converting the wavelength 41 light BLs made incident thereon.

The rotating body 67 is coupled to the second surface 622 of the rotating plate 62.

The driving source 66 rotates the rotating plate 62 and the rotating body 67 centering on the rotation axis Rx.

The suction part 68 is configured by combining the rotating plate 62 and the rotating body 67. The suction part 68 is provided on the inner side of the opening 623 when viewed from the side opposite to the driving source 66 with respect to the rotating plate 62. That is, the suction part 68 is provided on the inner side of the opening 623 when viewed from the +Z direction. The suction part 68 communicates with the space in the +Z direction with respect to the rotating plate 62 via the opening 623.

The plurality of fins 624 are disposed side by side around the suction part 68. Each of the plurality of fins 624 extends from the portion on the rotation axis Rx side toward the outer side of the rotating plate 62. The plurality of fins 624 are rotated together with the rotating plate 62 by the driving source 66. In the present embodiment, the plurality of fins 624 are provided on the second surface 622 of the rotating plate 62.

The plurality of flow paths 625 are provided among the plurality of fins 624. The plurality of flow paths 625 cause the air flow having flowed to the inside of the suction part 68 via the opening 623 to flow to the outside of the rotating body 67 centering on the rotation axis Rx.

With the configuration explained above, the same effects as the effects of the wavelength conversion device 5 according to the first embodiment can be achieved. Therefore, the light source device according to the present embodiment including the wavelength conversion device 6 and the projector according to the present embodiment including the light source device can achieve the same effects as the effects of the light source device 3 and the projector 1 according to the first embodiment.

The wavelength conversion device 6 according to the present embodiment can improve the cooling efficiency of the wavelength converter 53 like the wavelength conversion device 5 according to the first embodiment. Therefore, it is possible to cool the wavelength converter even if the rotating plate 62 is reduced in diameter. For this reason, by adopting the small-diameter rotating plate 62, a driving source having a low output can be adopted as the driving source 66 that drives the rotating plate 62. Further, since the plurality of fins 624 forming the plurality of flow paths 625 extend to the edge portion on the side opposite to the rotation axis Rx side in the rotating plate 62, the wavelength conversion device 6 according to the present embodiment can further improve the cooling efficiency of the wavelength converter 53 than the wavelength conversion device 5 according to the first embodiment. Therefore, the wavelength conversion device 6 can further contribute to a reduction in size and a reduction in power consumption than the wavelength conversion device 5 explained above.

Further, according to the generation of the air flow flowing toward the rotating plate 62, an air flow flows to the first condenser 37, which is the pickup optical system, illustrated in FIG. 2. Heat generated in the lenses 371, 372, and 373 of the first condenser 37 can be easily radiated to the air flow explained above. Therefore, it is possible to effectively cool the lenses 371, 372, and 373 that have generated heat when the blue light BLs and the fluorescent light YL have been made incident thereon.

In the wavelength conversion device 6, when viewed from the driving source 66 side with respect to the rotating plate 62, the first end portion 6241 on the rotation axis Rx side in each of the plurality of fins 624 is disposed on the outer side of the opening 623. That is, when viewed from the −Z direction, first end portions 6241 of the fins 624 are disposed on the outer side of the opening 623.

With the configuration explained above, it is possible to increase the volume in the suction part 68. This makes it possible to increase a flow rate of the air flow flowing into the suction space SP in the suction part 68 via the opening 623. Therefore, it is possible to improve the cooling efficiency of each of the wavelength converter 53 and the driving source 66.

In the wavelength conversion device 6, the second end portion 6242 on the side opposite to the rotation axis Rx in each of the plurality of fins 624 is disposed at the outer peripheral edge of the rotating plate 62. The outer peripheral edge corresponds to the edge portion on the side opposite to the rotation axis Rx in the rotating plate 62.

With the configuration explained above, when the plurality of fins 624 rotate, it is possible to increase a flow rate of the air flow flowing to the outer peripheral edge of the rotating plate 62. Besides, it is possible to increase a flow rate of the air flow flowing from the space on the driving source 66 side with respect to the rotating plate 62 toward the rotating plate 62 and increase a flow rate of the air flow flowing to the driving source 66. Therefore, it is possible to improve the cooling performance of each of the wavelength converter 53 provided in the rotating plate 62 and the driving source 66 can be enhanced.

In the wavelength conversion device 6, the rotating plate 62 includes the protrusion 626 protruding toward the rotating body 67. The rotating body 67 includes the flange 672 that engages with the protrusion 626. The flange 672 corresponds to the engaging part.

With the configuration explained above, it is possible to adjust the interval between the rotating plate 62 and the rotating body 67 by adjusting a protrusion dimension of the protrusion 626. This makes it possible to easily configure the suction part 68 to which the air flow flows via the opening 623.

The rotating body 67 may include a protrusion protruding toward the rotating plate 62. The rotating plate 62 may include an engaging part that engages with the protrusion. In this case, the same effects as the effects explained above can be achieved.

### Third Embodiment

Next, a third embodiment of the present disclosure is explained.

A projector according to the present embodiment includes the same components as the components of the projector according to the second embodiment but is different in that a rotating plate configuring a wavelength conversion device has a wall standing from a first surface and surrounding an opening. In the following explanation, portions that are the same or substantially the same as the portions explained above are denoted by the same reference numerals and signs and explanation of the portions is omitted.

### Configurations of the Projector and a Light Source Device

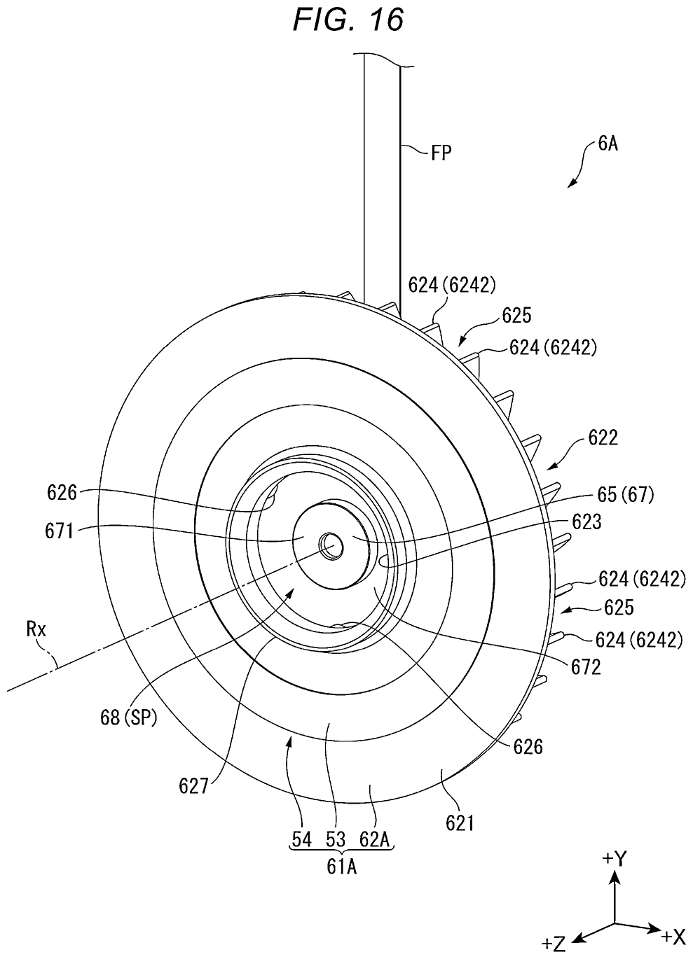

FIG. 16 is a perspective view illustrating a wavelength conversion device 6A of a light source device provided in the projector according to the present embodiment. Specifically, FIG. 16 is a perspective view illustrating the wavelength conversion device 6A viewed from the +Z direction. In FIG. 16, only some of the plurality of fins 624 are denoted by the reference numerals. Besides, only some of the plurality of flow paths 625 are denoted by the reference numerals.

The projector according to the present embodiment includes same components and functions as the components and the functions of the projector according to the second embodiment except that the projector includes the wavelength conversion device 6A illustrated in FIG. 16 instead of the wavelength conversion device 6 according to the second embodiment. That is, the light source device according to the present embodiment includes same components and functions as the components and the functions of the light source device 3 according to the first embodiment and the light source device according to the second embodiment except that the light source device includes the wavelength conversion device 6A instead of the wavelength conversion devices 5 and 6.

### Configuration of the Wavelength Conversion Device

The wavelength conversion device 6A includes same components and functions as the components and the functions of the wavelength conversion device 6 except that the wavelength conversion device 6A includes a phosphor wheel 61A instead of the phosphor wheel 61. That is, the wavelength conversion device 6A includes the phosphor wheel 61A, the driving device 65, and the suction part 68.

The phosphor wheel 61A includes same components and functions as the components and the functions of the phosphor wheel 61 according to the second embodiment except that the phosphor wheel 61A includes a rotating plate 62A instead of the rotating plate 62. That is, the phosphor wheel 61A includes the rotating plate 62A, the wavelength converter 53, and the reflecting part 54.

### Configuration of the Rotating Plate

As illustrated in FIG. 16, the rotating plate 62A includes same components and functions as the components and the functions of the rotating plate 62 except that the rotating plate 62A includes a wall 627. That is, the rotating plate 62A further includes the wall 627 besides including the first surface 621, the second surface 622, the opening 623, the plurality of fins 624, the plurality of flow paths 625, and the plurality of protrusions 626.

The wall 627 is provided on a side opposite to the driving source 66 in the rotating plate 62A, that is, the first surface 621 facing the +Z direction. The wall 627 stands in the +Z direction from the first surface 621 and is formed in a cylindrical shape surrounding the opening 623. Since the wall part 627 explained above is provided, an air flow flowing to the suction part 68 via the opening 623 is rectified.

In the present embodiment, the wall 627 is formed in a cylindrical shape having a substantially uniform outer diameter and a substantially uniform inner diameter centered on the rotation axis Rx. However, not only this, but the wall 627 may be formed in a shape in which at least one of the outer diameter and the inner diameter centered on the rotation axis Rx decreases as the wall 627 stands from the first surface 621 in the +Z direction or may be formed in a shape in which at least one of the outer diameter and the inner diameter centered on the rotation axis Rx increases as the wall 627 stands from the first surface 621 in the +Z direction.

### Effects of the Third Embodiment

The projector according to the present embodiment explained above achieves the following effects besides achieving the same effects as the effects of the projector according to the second embodiment.

In the wavelength conversion device 6A, the first surface 621 of the rotating plate 62A is a surface facing the side opposite to the driving source 66 in the rotating plate 62A. That is, the first surface 621 is a surface facing the +Z direction.

The rotating plate 62A includes the wall 627 standing in the +Z direction from the first surface 621 and surrounding the opening 623.

With the configuration explained above, an air flow flowing into the suction part 68 via the opening 623 can be rectified by the wall part 627. Accordingly, since flow velocity and a flow rate of the air flow flowing into the suction part 68 can be increased, it is possible to increase flow velocity and a flow rate of an air flow flowing along the second surface 622 on the driving source 66 side in the rotating plate 62. Besides, it is possible to increase flow velocity and a flow rate of an air flow flowing along the driving source 66 toward the second surface 622 of the rotating plate 62. Therefore, it is possible to further improve the cooling efficiency of each of the wavelength converter 53 and the driving source 66.

### Fourth Embodiment

Next, a fourth embodiment of the present disclosure is explained.

A projector according to the present embodiment includes the same components as the components of the projector according to the second embodiment but is different in a configuration of a plurality of fins provided on a rotating plate configuring a wavelength conversion device.

In the following explanation, portions that are the same or substantially the same as the portions explained above are denoted by the same reference numerals and signs and explanation of the portions is omitted.

### Configurations of the Projector and a Light Source Device

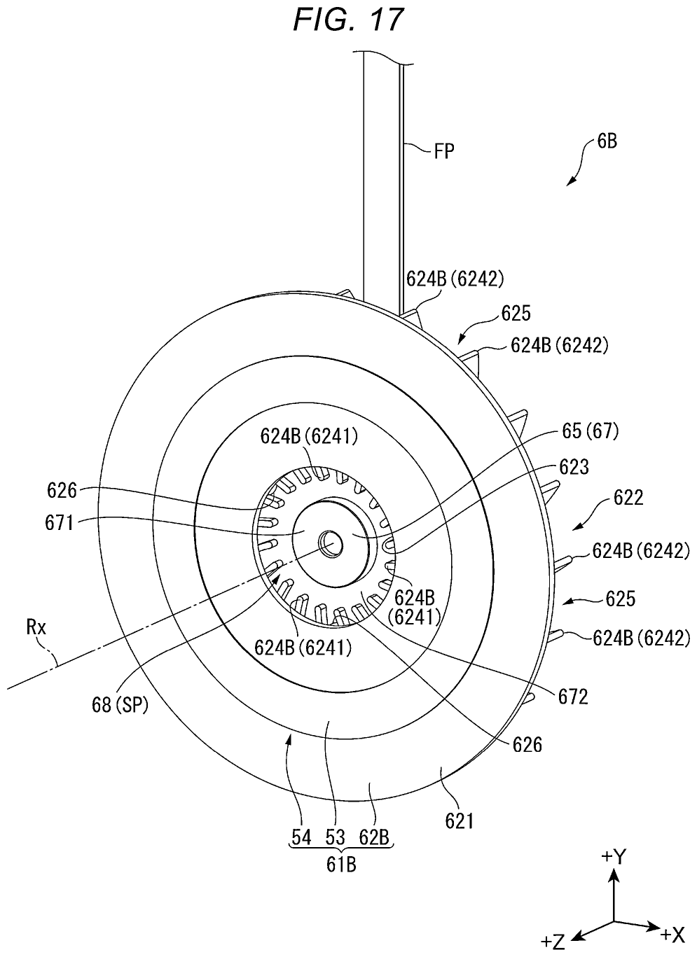

FIG. 17 is a perspective view illustrating a wavelength conversion device 6B of a light source device provided in the projector according to the present embodiment. Specifically, FIG. 17 is a perspective view illustrating the wavelength conversion device 6B viewed from the +Z direction. In FIG. 17, only some of a plurality of fins 624B are denoted by the reference signs and only some of the plurality of flow paths 625 are denoted by the reference numerals.

The projector according to the present embodiment includes same components and functions as the components and the functions of the projector according to the second embodiment except that the projector includes the wavelength conversion device 6B illustrated in FIG. 17 instead of the wavelength conversion device 6 according to the second embodiment. That is, the light source device according to the present embodiment includes same components and functions as the components and the functions of the light source devices according to the first to third embodiments except that the light source device includes the wavelength conversion device 6B instead of the wavelength conversion devices 5, 6, and 6A.

### Configuration of the Wavelength Conversion Device

The wavelength conversion device 6B includes same components and functions as the components and the functions of the wavelength conversion device 6 except that the wavelength conversion device 6B includes a phosphor wheel 61B instead of the phosphor wheel 61. That is, the wavelength conversion device 6B includes the phosphor wheel 61B, the driving device 65, and the suction part 68.

The phosphor wheel 61B includes same components and functions as the components and the functions of the phosphor wheel 61 according to the second embodiment except that the phosphor wheel 61B includes a rotating plate 62B instead of the rotating plate 62. That is, the phosphor wheel 61B includes the rotating plate 62B, the wavelength converter 53, and the reflecting part 54.

### Configuration of the Rotating Plate

The rotating plate 62B includes same components and functions as the components and the functions of the rotating plate 62 except that the rotating plate 62B includes a plurality of fins 624B instead of the plurality of fins 624. That is, the rotating plate 62B includes the first surface 621, the second surface 622, the opening 623, the plurality of fins 624B, the plurality of flow paths 625, and the plurality of protrusions 626. Each of the plurality of flow paths 625 is provided between two fins 624B adjacent to each other among the plurality of fins 624B. The rotating plate 62B may further include the wall 627 according to the third embodiment.

The plurality of fins 624B are disposed side by side around the suction part 68. Each of the plurality of fins 624B extends from a portion on the rotation axis Rx side toward the outer side of the rotating plate 62B. Specifically, the plurality of fins 624B respectively extend from the portion on the rotation axis Rx side toward the outer side of the rotating plate 62B and are disposed around the suction part 68 side by side along the circumferential direction centered on the rotation axis Rx. Like the plurality of fins 624, the plurality of fins 624B include the coupling parts 6243 not illustrated in FIG. 17 besides including the first end portions 6241 and the second end portions 6242.

In the fin 624 according to the second embodiment, the first end portion 6241 on the rotation axis Rx side is disposed on the outer side or the outside of the opening 623. In contrast, in the fin 624B according to the present embodiment, the first end portion 6241 on the rotation axis Rx side is disposed on the inner side or the inside of the opening 623 when viewed from the +Z direction.

For this reason, when the plurality of fins 624B are rotated together with the rotating plate 62B, it is possible to cause an air flow flowing into the suction space SP in the suction part 68 to easily flow to the outside of the rotating body 67 via the plurality of flow paths 625.

### Effects of the Fourth Embodiment

The projector according to the present embodiment explained above achieves the following effects besides achieving the same effects as the effects of the projector according to the second embodiment.

In the wavelength conversion device 6B, the first end portion 6241 on a side opposite to the driving source 66 with respect to the rotating plate 62B, that is, on the rotation axis Rx side in each of the plurality of fins 624B when viewed from the +Z direction is disposed on the inner side or the inside of the opening 623.

With the configuration explained above, with the rotating plurality of fins 624B, it is possible to cause the air flow having flowed in the suction part 68 via the opening 623 to quickly flow to the outside of the rotating body 67. This makes it possible to increase a flow rate of an air flow flowing into the suction part 68 and increase a flow rate of an air flow flowing along the second surface 622 of the rotating plate 62B. Therefore, it is possible to improve the cooling efficiency of each of the wavelength converter 53 and the driving source 66.

### Fifth Embodiment

Next, a fifth embodiment of the present disclosure is explained.

A projector according to the present embodiment includes the same components as the components of the projector according to the second embodiment but is different in a configuration of a plurality of fins provided on a rotating plate configuring a wavelength conversion device.

In the following explanation, portions that are the same or substantially the same as the portions explained above are denoted by the same reference numerals and signs and explanation of the portions is omitted.

### Configurations of the Projector and a Light Source Device

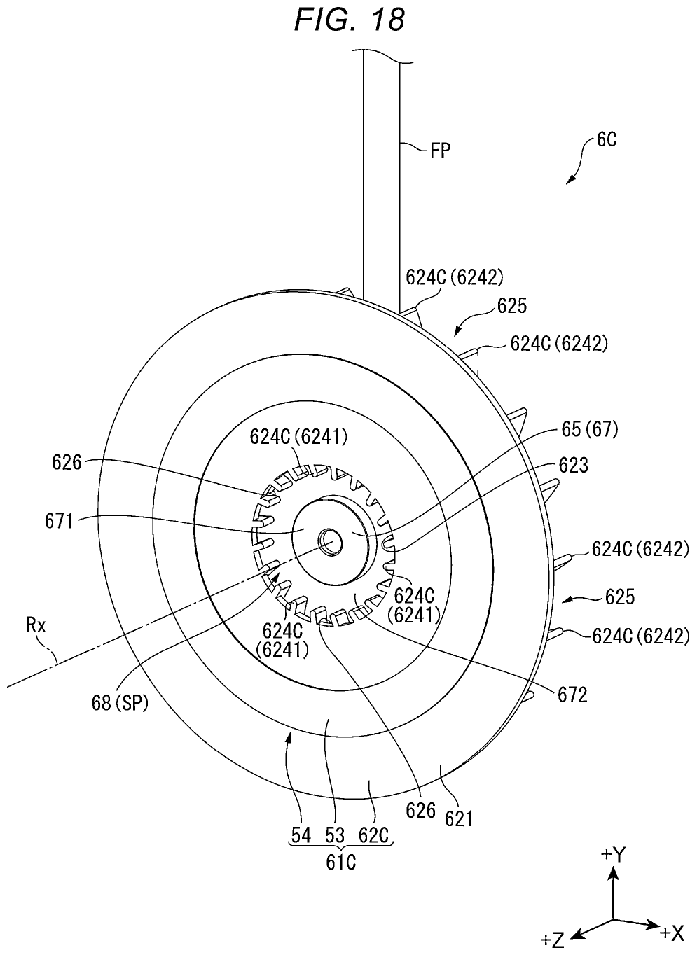

FIG. 18 is a perspective view illustrating a wavelength conversion device 6C of a light source device provided in the projector according to the present embodiment. Specifically, FIG. 18 is a perspective view illustrating the wavelength conversion device 6C viewed from the +Z direction. In FIG. 18, only some of a plurality of fins 624C are denoted by the reference signs and only some of the plurality of flow paths 625 are denoted by the reference numerals.

The projector according to the present embodiment includes the same components and functions as the components and the functions of the projector according to the second embodiment except that the projector includes the wavelength conversion device 6C illustrated in FIG. 18 instead of the wavelength conversion device 6 according to the second embodiment. That is, the light source device according to the present embodiment includes the same components and functions as the components and the functions of the light source devices according to the first to fourth embodiments except that the light source device includes the wavelength conversion device 6C instead of the wavelength conversion devices 5, 6, 6A, and 6B.

### Configuration of the Wavelength Conversion Device

The wavelength conversion device 6C includes the same components and functions as the components and the functions of the wavelength conversion device 6 except that the wavelength conversion device 6C includes a phosphor wheel 61C instead of the phosphor wheel 61. That is, the wavelength conversion device 6C includes the phosphor wheel 61C, the driving device 65, and the suction part 68.

The phosphor wheel 61C includes the same components and functions as the components and the functions of the phosphor wheel 61 according to the second embodiment except that the phosphor wheel 61C includes a rotating plate 62C instead of the rotating plate 62. That is, the phosphor wheel 61C includes the rotating plate 62C, the wavelength converter 53, and the reflecting part 54.

### Configuration of the Rotating Plate

The rotating plate 62C includes the same components and functions as the components and the functions of the rotating plate 62 except that the rotating plate 62C includes a plurality of fins 624C instead of the plurality of fins 624. That is, the rotating plate 62C includes the first surface 621, the second surface 622, the opening 623, the plurality of fins 624C, the plurality of flow paths 625, and the plurality of protrusions 626. Each of the plurality of flow paths 625 is provided between two fins 624C adjacent to each other among the plurality of fins 624C. The rotating plate 62C may further include the wall 627 according to the third embodiment.

The plurality of fins 624C are disposed side by side around the suction part 68. Each of the plurality of fins 624C extends from a portion on the rotation axis Rx side toward the outer side of the rotating plate 62C. Specifically, the plurality of fins 624C respectively extend from the portion on the rotation axis Rx side toward the outer side of the rotating plate 62C and are disposed around the suction part 68 side by side along the circumferential direction centered on the rotation axis Rx. Like the plurality of fins 624, the plurality of fins 624C include the coupling parts 6243 not illustrated in FIG. 18 besides including the first end portions 6241 and the second end portions 6242.

The first end portions 6241 on the rotation axis Rx side in the fins 624C protrude from the peripheral edge of the opening 623 toward the inner side of the opening 623 in the radial direction of the rotating plate 62C. In other words, the first end portions 6241 of the fins 624C are disposed on the inner side or the inside of the opening 623.

### Effects of the Fifth Embodiment

The projector according to the present embodiment explained above achieves the same effects as the effects of the projector according to the fourth embodiment.

Besides, a part of the fin 624C protrudes from the peripheral edge of the opening 623 toward the inner side or the inside of the opening 623. This makes it possible to easily guide an air flow flowing into the suction part 68 via the opening 623 to the plurality of flow paths 625 provided among the plurality of fins 624C. Therefore, since it is possible to cause the air flow to easily flow along the second surface 622 of the rotating plate 62C, it is possible to improve the cooling efficiency of each of the wavelength converter 53 and the driving source 66.

### MODIFICATIONS OF THE EMBODIMENTS

The present disclosure is not limited to the embodiments explained above, and modifications, improvements, and the like to the extent that the object of the present disclosure is achieved are included in the present disclosure.

In the first embodiment, the rotating plate 52 includes one opening 523 including the rotation axis Rx when viewed from the +Z direction. However, not only this, but the opening provided in the rotating plate 52 may not be one opening, and the opening may not include the rotation axis Rx when viewed from the +Z direction.

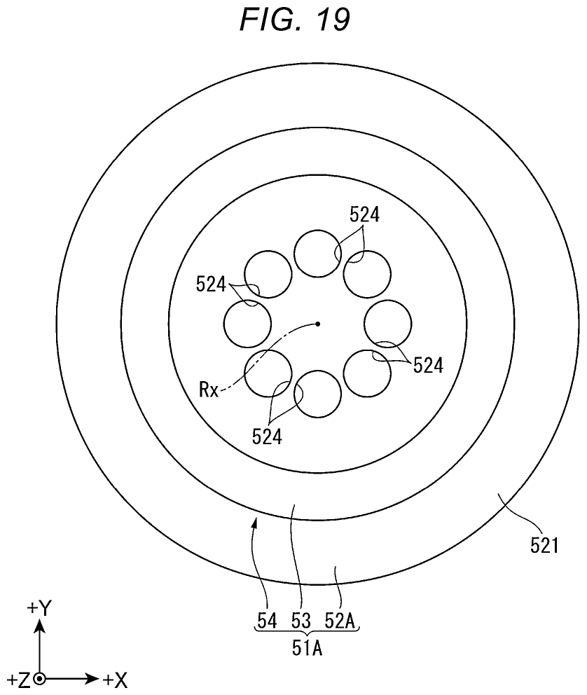

FIG. 19 is a diagram of a phosphor wheel 51A, which is a first modification of the phosphor wheel 51, viewed from the +Z direction.

For example, the phosphor wheel 51A includes a rotating plate 52A and the wavelength converter 53 and the reflecting part 54 provided on the first surface 521 of the rotating plate 52A.

The rotating plate 52A includes the same functions and components as the functions and the components of the rotating plate 52 except that the rotating plate 52A includes a plurality of openings 524 instead of the opening 523. The plurality of openings 524 are disposed side by side in the circumferential direction centered on the rotation axis Rx. Each of the plurality of openings 524 is formed in a circular shape when viewed from the +Z direction. The suction part 574 communicates with a space in the +Z direction with respect to the rotating plate 52A via the plurality of openings 524.

In an example illustrated in FIG. 19, eight openings 524 are provided. However, not only this, but the number of the openings 524 can be changed as appropriate if the number is one or more.

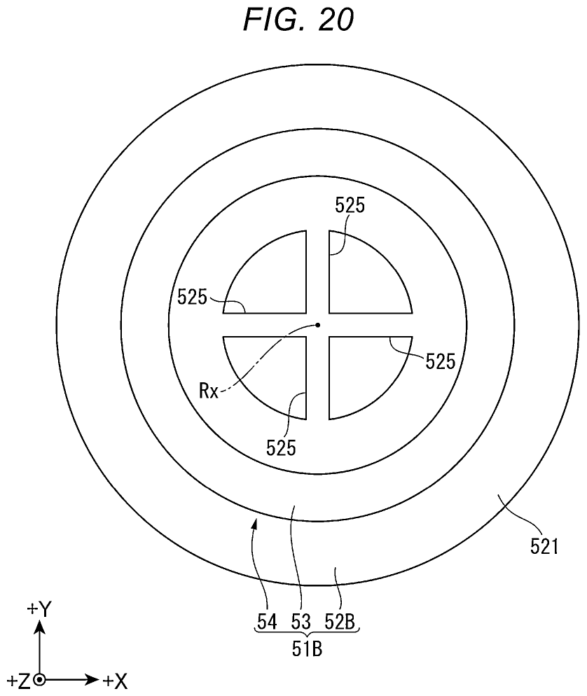

FIG. 20 is a diagram of a phosphor wheel 51B, which is a second modification of the phosphor wheel 51, viewed from the +Z direction.

For example, the phosphor wheel 51B includes a rotating plate 52B and the wavelength converter 53 and the reflecting part 54 provided on the first surface 521 of the rotating plate 52B.

The rotating plate 52B includes the same functions and components as the functions and the components of the rotating plate 52 except that the rotating plate 52B includes a plurality of openings 525 instead of the opening 523. The plurality of openings 525 are disposed side by side in the circumferential direction centered on the rotation axis Rx. Each of the plurality of openings 525 is formed in a fan shape when viewed from the +Z direction. The suction part 574 communicates with a space in the +Z direction with respect to the rotating plate 52B via the plurality of openings 525.

In an example illustrated in FIG. 20, four openings 525 are provided. However, not only this, but the number of the openings 525 can be changed as appropriate if the number is one or more.

Even when the rotating plates 52A and 52B are adopted in the wavelength conversion device 5 instead of the rotating plate 52, it is possible to achieve the same effects as the effects explained above achieved by the wavelength conversion device 5 including the rotating plate 52.

The number, the shape, and the layout of openings provided in the rotating plate explained above are also applicable to the rotating plates 62, 62A, 62B, and 62C. In this case, the plurality of fins 624 and 624B may be provided on the outer side of a region where the plurality of openings are provided in the rotating plate.

The openings provided in the rotating plate may not overlap the driving sources 56 and 66 when viewed along the rotation axis Rx. That is, the openings may not overlap the driving sources 56 and 66 when viewed from the +Z direction and may be provided at positions on the outer side of the driving sources 56 and 66 on the rotating plate.

In the embodiments explained above, the wavelength converter 53 is provided on the first surfaces 521 and 621 of the rotating plates 52, 52A, 52B, 62, 62A, 62B, and 62C. However, not only this, but the wavelength converter 53 may be provided on the second surfaces 522 and 622 of the rotating plates 52, 52A, 52B, 62, 62A, 62B, and 62C. In this case, the blue light BLs, which is the excitation light, may be made incident on the wavelength converter 53 from the −Z direction. When the rotating plates 52, 52A, 52B, 62, 62A, 62B, and 62C have optical transparency, the blue light BLs may be made incident on the wavelength converter 53 from the +Z direction via the rotating plate.

When the wavelength converter 53 is provided on the second surface 622, the plurality of fins 624, 624B, and 624C may be provided to avoid the wavelength converter 53.

In the above embodiments, the wavelength conversion devices 5, 6A, 6B, and 6C are the wavelength conversion devices of the reflection type that emit converted light to an incident side of excitation light. However, not only this, but the wavelength conversion device of the present disclosure may be a wavelength conversion device of a transmission type that emits converted light along an incident direction of excitation light. In this case, the rotating plates 52, 52A, 52B, 62, 62A, 62B, and 62C only have to have light transmission characteristics.

As explained above, the plurality of fins 624, 624B, and 624C only have to be provided to avoid an optical path of light made incident on the wavelength converter 53 and an optical path of light emitted from the wavelength converter 53.

In the first embodiment, the rotating plate 52 and the driving source 56 are coupled via the plurality of fins 575 provided in the rotating body 57. In the second to fifth embodiments, the rotating plates 62, 62A, 62B, and 62C and the driving source 66 are coupled via the plurality of fins 624, 624B, and 624C provided on the rotating plates 62, 62A, 62B, and 62C. However, not only this, but the rotating plate 52 and the driving source 56 may not be coupled via a plurality of fins.

On the other hand, if the rotating plate 52 and the driving source 56 can be coupled by a plurality of fins, the protrusions 626, and the insertion holes 673 may be absent.

That is, a coupling form of the rotating plate and the rotating body and a coupling form of the rotating body and the driving source are not limited to the above description.

In the third embodiment, the rotating plate 62A may include the wall 627 and the rotating plates 62B and 62C according to the fourth and fifth embodiments may include the wall 627. Besides, the rotating plate 52 according to the first embodiment may include the same wall as the wall 627.

In the embodiments explained above, the projector includes the three light modulators 243R, 243G, and 243B. However, not only this, but the present disclosure is also applicable to a projector including two or less or four or more light modulators.

In the embodiments explained above, the image projection device 2 has the layout of the optical components illustrated in FIG. 1. However, not only this, but the optical components provided in the image projection device 2 and the layout of the optical components are not limited to the above description.

In the embodiments explained above, the liquid crystal panel of the transmission type in which a light incident surface and a light emission surface are different is exemplified as the light modulator 243. However, not only this, but the light modulator adopted in the projector of the present disclosure may have a configuration including a liquid crystal panel of a reflection type in which a light incident surface and a light emission surface are the same. A light modulator other than liquid crystal such as a device using a micro mirror, for example, a device using a DMD (Digital Micromirror Device) or the like may be applied to the projector if the light modulator is a light modulation device capable of modulating an incident light flux to form an image corresponding to image information.

In the embodiments explained above, an example in which the wavelength conversion devices 5, 6, 6A, 6B, and 6C are applied to the light source device 3 is explained and an example in which the light source device 3 including the wavelength conversion devices 5, 6, 6A, 6B, and 6C is applied to the projector is explained. However, not only this, but the wavelength conversion device of the present disclosure may be used in electronic equipment other than the light source device. The light source device of the present disclosure may be used in electronic equipment other than the projector, for example, electronic equipment such as an illumination device.

### SUMMARY OF THE PRESENT DISCLOSURE

A summary of the present disclosure is appended below.

### Appendix 1

A wavelength conversion device including:
a rotating plate having a first surface, a second surface on an opposite side to the first surface, and an opening penetrating the rotating plate from the first surface to the second surface;
a wavelength converter disposed further on an outer side than the opening in a radial direction of the rotating plate and configured to emit converted light obtained by converting a wavelength of excitation light made incident on the wavelength converter;
a rotating body coupled to the rotating plate;
a driving source configured to rotate the rotating plate and the rotating body centering on a rotation axis;
a suction part configured by combining the rotating plate and the rotating body, provided on an inner side of the opening when viewed from a side opposite to the driving source with respect to the rotating plate, and communicating with, via the opening, a space on the side opposite to the driving source with respect to the rotating plate;
a plurality of fins respectively extending from a portion on the rotation axis side toward an outer side of the rotating plate, disposed side by side around the suction part, and rotated together with the rotating plate by the driving source; and
a plurality of flow paths provided among the plurality of fins and configured to cause an air flow flowing into an inside of the suction part via the opening to flow to an outside of the rotating body.

With the configuration explained above, when the rotating plate and the rotating body are rotated by the driving source, a space in the suction part has negative pressure with the plurality of fins provided around the suction part, and an air flow flows from the space on the side opposite to the driving source with respect to the rotating plate toward the opening.

A part of an air flow flowing toward the opening collides with a surface on the side opposite to the driving source in the rotating plate and flows along the surface on the opposite side to cool the rotating plate.

On the other hand, another part of the air flow flowing toward the opening flows into the suction part via the opening. The air flow flowing into the suction part cools the driving source via the rotating body. Further, the plurality of fins are rotated, whereby the air flow flowing into the suction part flows to the outside of the rotating body centering the rotation axis through the plurality of flow paths. The air flow explained above flows along a surface on the driving source side in the rotating plate to cool the rotating plate.

Here, the heat of the wavelength converter provided in the rotating plate is transferred to the entire rotating plate. For this reason, both surfaces of the rotating plate are cooled and the wavelength converter is also cooled by an air flow flowing along the surface on the side opposite to the driving source in the rotating plate and an air flow flowing along the surface on the driving source side in the rotating plate.

Further, when the plurality of fins rotate, an air flow also flows toward the rotating plate from a space on the driving source side with respect to the rotating plate. Since a part of the air flow explained above flows along the driving source, the driving source is cooled by the part of the air flow.

Besides, at least a part of the suction part to which an air flow flows via the opening includes the rotating body coupling the driving source and the rotating plate, and the plurality of flow paths for causing the air flow flowing to the inside of the suction part to flow to the outer side of the rotating body are provided around the suction part. For this reason, heat is less easily transferred from the rotating plate to the driving source. This makes it possible to prevent the heat of the rotating plate on which the wavelength converter is disposed from being transferred to the driving source.

As explained above, it is possible to prevent the heat of the wavelength converter from being easily transferred to the driving source. Besides, it is possible to cool the driving source and the rotating plate and also cool the wavelength converter with an air flow generated by the rotation of the plurality of fins. Therefore, it is possible to improve the cooling efficiency of each of the driving source and the wavelength converter.

### Appendix 2

In the wavelength conversion device according to the appendix 1, an end portion on the rotation axis side in each of the plurality of fins may be disposed on an inside of the opening when viewed from the side opposite to the driving source with respect to the rotating plate.

With the configuration explained above, with the rotating plurality of fins, it is possible to cause the air flow having flowed into the suction part via the opening to quickly flow to the outside of the rotating body. This makes it possible to increase a flow rate of the air flow flowing into the suction part and increase a flow rate of the air flow flowing along the surface on the driving source side in the rotating plate. Therefore, it is possible to improve the cooling efficiency of each of the wavelength converter and the driving source.

### Appendix 3

In the wavelength conversion device according to the appendix 1, an end portion on the rotation axis side in each of the plurality of fins may be disposed on an outer side of the opening when viewed from the driving source side with respect to the rotating plate.

With the configuration explained above, it is possible to increase the volume in the suction part. Therefore, it is possible to increase a flow rate of the air flow flowing into the suction part via the opening. Therefore, it is possible to improve the cooling efficiency of each of the wavelength converter and the driving source.

### Appendix 4

In the wavelength conversion device according to the appendix 2 or 3, an end portion on a side opposite to the rotation axis side in each of the plurality of fins may be disposed at an edge portion on a side opposite to the rotation axis side in the rotating plate.

With the configuration explained above, when the plurality of fins rotate, it is possible to increase a flow rate of an air flow flowing to the peripheral edge of the rotating plate. Besides, it is possible to increase a flow rate of an air flow flowing from the space on the driving source side with respect to the rotating plate toward the rotating plate. It is possible to increase a flow rate of an air flow flowing to the driving source. Accordingly, the cooling performance of each of the wavelength converter and the driving source provided on the rotating plate can be enhanced.

### Appendix 5

In the wavelength conversion device according to any one of the appendixes 1 to 4, the rotating plate and the driving source may be coupled via the plurality of fins.

With the configuration explained above, it is possible to easily configure the suction part around which the plurality of fins are provided while reducing the interval between the rotating plate and the driving source. Therefore, it is possible to reduce the wavelength conversion device in size in a direction along the rotation axis.

### Appendix 6

In the wavelength conversion device according to any one of the appendixes 1 to 4, one of the rotating plate and the rotating body may include a protrusion protruding toward another of the rotating plate and the rotating body, and the other of the rotating plate and the rotating body may include an engaging part engaging with the protrusion.

With the configuration explained above, it is possible to adjust the interval between the rotating plate and the rotating body by adjusting a protrusion dimension of the protrusion. This makes it possible to easily configure the suction part to which the air flow flows via the opening.

### Appendix 7

In the wavelength conversion device according to any one of the appendixes 1 to 6, the first surface may be a surface facing the side opposite to the driving source in the rotating plate, and the rotating plate may include a wall standing from the first surface and surrounding the opening.

With the configuration explained above, the wall can rectify the air flow flowing into the suction part via the opening. Accordingly, it is possible to increase the flow velocity and the flow rate of the air flow flowing into the suction part, and thus it is possible to increase the flow velocity and the flow rate of the air flow flowing along the surface of the rotating plate on the driving source side, and it is possible to increase the flow velocity and the flow rate of the air flow flowing along the driving source toward the rotating plate. Accordingly, the cooling efficiency of each of the wavelength converter and the driving source can be further enhanced.

### Appendix 8

In the wavelength conversion device according to any one of the appendixes 1 to 7, the opening may overlap the driving source when viewed along the rotation axis.

With the configuration explained above, it is possible to cause the air flow having flowed into the suction part to easily flow to the rotating body and also to the driving source. Therefore, it is possible to improve the cooling efficiency of the driving source.

### Appendix 9

In the wavelength conversion device according to the appendix 8, an extension line of the rotation axis may pass through the opening.

With the configuration explained above, the opening is disposed on the rotation axis. For this reason, when the rotating plate and the rotating body rotate, the opening can easily have negative pressure. It is possible to cause the air flow to easily flow into the suction part via the opening. Therefore, since a flow rate of the air flow flowing to the rotating plate and the rotating body can be increased, it is possible to further improve the cooling efficiency of each of the wavelength converter and the driving source.

Here, it is conceivable that the opening is formed in the rotating plate by punching. When a plurality of openings are provided in the rotating plate by the method explained above, the rotating plate is distorted, causing deformation of the wavelength converter, and also causing damage to the wavelength converter. For this reason, it is necessary to examine a configuration for suppressing the deformation of the wavelength converter.

In contrast, since the opening is disposed on the rotation axis, one opening is provided in the rotating plate. For this reason, it is possible to prevent distortion from occurring in the rotating plate. It is possible to prevent deformation and damage from occurring in the wavelength converter.

### Appendix 10

A light source device including:
the wavelength conversion device according to any one of the appendixes 1 to 9;
a case housing the wavelength conversion device; and
a light source configured to emit excitation light to be made incident on the wavelength conversion device, wherein
the case includes an emitting part configured to emit the converted light to an outside.

With the configuration explained above, it is possible to achieve the same effects as the effects of the wavelength conversion device.

Besides, the air flow having flowed along the rotating plate convectively flows in the case and thereafter flows again toward the suction part according to the rotation of the plurality of fins. Therefore, the air flow in the case circulates. In this way, since the air flow flowing toward the suction part is the air flow having convectively flowed in the case, it is possible to lower the temperature of the air flow flowing to the wavelength conversion device. Therefore, it is possible to improve the cooling efficiency of each of the wavelength converter and the driving source.

Since the air flow in the case is circulated to cool the wavelength conversion device, a sealed case can be adopted as the case for housing the wavelength conversion device. In this case, it is possible to prevent dust from intruding into the case. It is possible to prevent dust from adhering to the light source and the wavelength conversion device.

Further, it is also possible to cool other optical components disposed in the case with the air flow circulating in the case. Therefore, it is possible to improve the cooling efficiency of the entire light source device.

### Appendix 11

A projector including:
the light source device according to the appendix 10;
an image forming device configured to modulate light emitted from the light source device to form image light; and
a projection optical device configured to project the image light formed by the image forming device.

With the configuration explained above, it is possible to achieve the same effects as the effects of the light source device. Since the cooling efficiency of the wavelength conversion device can be improved, it is possible to suppress deterioration in the image quality of a projected image. Besides, it is possible to extend the life of the projector.

What is claimed is:

1. A wavelength conversion device comprising:
a rotating plate having a first surface, a second surface on an opposite side to the first surface, and an opening penetrating the rotating plate from the first surface to the second surface;
a wavelength converter disposed further on an outer side than the opening in a radial direction of the rotating plate and configured to emit converted light obtained by converting a wavelength of excitation light made incident on the wavelength converter;
a rotating body coupled to the rotating plate;
a driving source configured to rotate the rotating plate and the rotating body centering on a rotation axis;
a suction part configured by combining the rotating plate and the rotating body, and provided on an inner side of the opening when viewed from a side opposite to the driving source with respect to the rotating plate, the suction part communicating with, via the opening, a space on the side opposite to the driving source with respect to the rotating plate;
a plurality of fins respectively extending from a portion on a rotation axis side toward an outer side of the rotating plate, disposed side by side around the suction part, and rotated together with the rotating plate by the driving source; and
a plurality of flow paths provided among the plurality of fins and configured to cause an air flow flowing into an inside of the suction part via the opening to flow to an outside of the rotating body.

2. The wavelength conversion device according to claim 1, wherein an end portion on the rotation axis side in each of the plurality of fins is disposed on an inside of the opening when viewed from the side opposite to the driving source with respect to the rotating plate.

3. The wavelength conversion device according to claim 1, wherein an end portion on the rotation axis side in each of the plurality of fins is disposed on an outer side of the opening when viewed from the driving source side with respect to the rotating plate.

4. The wavelength conversion device according to claim 2, wherein an end portion on a side opposite to the rotation axis side in each of the plurality of fins is disposed at an edge portion on a side opposite to the rotation axis side in the rotating plate.

5. The wavelength conversion device according to claim 1, wherein the rotating plate and the driving source are coupled via the plurality of fins.

6. The wavelength conversion device according to claim 1, wherein
one of the rotating plate and the rotating body includes a protrusion protruding toward the other of the rotating plate and the rotating body, and
the other of the rotating plate and the rotating body includes an engaging part engaging with the protrusion.

7. The wavelength conversion device according to claim 1, wherein
the first surface is facing the side opposite to the driving source in the rotating plate, and
the rotating plate includes a wall standing from the first surface and surrounding the opening.

8. The wavelength conversion device according to claim 1, wherein the opening overlaps the driving source when viewed along the rotation axis.

9. The wavelength conversion device according to claim 8, wherein an extension line of the rotation axis passes through the opening.

10. A light source device comprising:
the wavelength conversion device according to claim 1;
a case housing the wavelength conversion device; and
a light source configured to emit excitation light, wherein
the case includes an emitting part configured to emit the converted light to an outside.

11. A projector comprising:
the light source device according to claim 10;
an image forming device configured to modulate light emitted from the light source device to form image light; and
a projection optical device configured to project the image light formed by the image forming device.
